(19) United States
(12) Patent Application Publication
(10) Pub. No.: US 2018/0165722 A1
(43) Pub. Date: Jun. 14, 2018

(54) SYSTEM AND METHOD FOR ASSISTING PARTIES IN A BUSINESS ENVIRONMENT

(71) Applicant: Floorwatch, Inc., Plymouth, MA (US)

(72) Inventor: William F. Mirabito, JR., Plymouth, MA (US)

(21) Appl. No.: 15/836,373

(22) Filed: Dec. 8, 2017

Related U.S. Application Data
(60) Provisional application No. 62/432,206, filed on Dec. 9, 2016.

(51) Int. Cl. G06Q 30/02; H04W 4/021; G06F 3/048; H04L 12/58

(52) U.S. Cl. CPC G06Q 30/0281; H04L 51/046; G06F 3/048; H04W 4/021

(57) ABSTRACT

The present disclosure is generally directed to computer-enabled communications and applications so as to assist retailers, restaurant owners, service staff, retail associates and retail customers. Geo-fencing of parties in a retail environment selectively places a party requesting assistance with a relevant party able to provide the assistance at or proximal to a retail location.

### RELATED APPLICATIONS

This application claims the benefit of and priority to U.S. Provisional Application No. 62/432,206, filed on Dec. 9, 2016, entitled “SYSTEM AND METHOD FOR ASSISTING PARTIES IN A RETAIL ENVIRONMENT,” which is incorporated by reference herein in its entirety.

### TECHNICAL FIELD

The present application relates to automated means for assisting retail customers and store associates and retailers in general. In particular, the application relates to locating and communications among customers, retail associates and others in the context of assisting parties in a retail environment. The present application also relates to automated means for assisting restaurant patrons and restaurant servers and restaurants in general. In particular, the application relates to locating and communications among restaurant patrons, restaurant servers and others in the context of assisting parties in a restaurant environment.

### BACKGROUND

Surveys of smartphone users have confirmed that the majority of customers prefer the retail store experience over online shopping, and that customers enjoy the excitement of shopping at a physical retail store. Most consumers also said that they prefer self-service when visiting stores. However, in addition, most such consumers said that they find store associates helpful when making an in-store purchase decision. Other surveys have confirmed that customers very often blend store, web and mobile shopping tools when they shop. Consumers say that they do not usually want help when they first arrive at a store. But when they most need assistance, they like having a retail associate available and ready to help. If a retail associate is not available to help when needed, the customer's experience is negatively impacted, in which cases the customer may turn to his or her smartphone for information and assistance.

We live in an age where smartphones are ubiquitous, and digital consumers may be socially inhibited. Consumers may not remember phone numbers, but often store them in contact lists. People may not write emails, but they increasingly communicate using short text messages, Facebook posts, and Twitter tweets. Consumers thus expect help at the press of a button, like when calling for a flight attendant on a commercial aircraft.

Minimum wage increases and reduced store traffic have made it increasingly difficult for retailers to control store payroll, maintain service levels, manage inventory, and deliver on customer expectations. Therefore, it is challenging for retail store owners to hire and maintain fully staffed physical store locations in case of need.

Compounding these challenges, is that retail stores have grown in size and have diversified in their offerings as well as in their geographic locations. Retail stores, whether specialty based (e.g., consumer electronics, hardware) or general merchandisers (e.g., retail box stores) offer an ever-increasing range of goods and services on location. The square footage under the roof of a modern super store dwarfs common store sizes of a few years ago. Customers therefore struggle to know what and where goods are kept in a given store location. Other complexities such as obtaining qualified assistance in selection, fitting or answering questions about the merchandise challenge both customers and store staff (retail associates). When stores were smaller a customer could learn his or her way around the store and generally know where to find a given product (e.g., in a neighborhood grocery or hardware store). This is no longer true for massive retail establishments. Also, a customer in years past who needed assistance could walk the few steps to the Help Desk, or peer around a merchandise rack to locate an associate on duty for help with the merchandise of interest. This is now a much more difficult undertaking, as wandering the isles of large box stores can consume some time and requires more patience. In addition, a store associate at a small retailer was more likely to know the answers to the limited questions regarding the products in their store, whereas today, large retail locations simultaneously offer goods that can range from automotive to clothing to foods to art supplies and beyond, making it necessary to hire specialized associates who work in respective departments of the store and who are generally ignorant as to the myriad products in the store as a whole, to put it mildly. The end result of this is that it is much more difficult today to find qualified assistance while shopping at a retail store, both as far as finding the human associates on duty and as far as obtaining competent help from the associates once they are found.

Retailers and restaurants are developing proprietary applications, and deploying new hardware to store locations. Consumer adoption of in-store technology is early and relatively expensive. Users still prefer their own devices; and consumers may not want to acquire and learn a new software for each retail store or restaurant chain they frequent. For this reason, many consumers have embraced services like Uber, Airbnb, OpenTable, Yelp and similar cloud-based service apps.

Another issue is that facing retailers who currently have little insight into the behavior and needs of their store customers. This insight could improve customer service and improve the overall good will and possible profitability of retailers who appreciate their customers' needs.

Patrons of full service restaurants may require the help of a server several times during a visit: to get drinks, order food, or pay the bill. The server is typically covering many tables, which require service quickly and on demand. The situation is compounded when another server calls out sick.

These and other current retail and service industry challenges are addressed in the following disclosure.

### SUMMARY

It has been determined that it is possible to provide technological processes to further assist customers and/or other parties.

At least some embodiments facilitate interactive communication between a computing device of a customer and/or other party that is within (or otherwise satisfies spatial criteria related to) a store or restaurant (or other type of business operation) and a computing device of an associate of the business operation.

The technological processes are a significant improvement over current technological processes available to assist customers and/or other parties.

In at least some aspects, a method comprises: receiving, by a processing system, a message from a computing device, the message including a request for assistance and/or to provide a review relating to a business operation at a location; determining, by the processing system, if access criteria of a customer assistance and/or customer review service associated with the business operation at the location is satisfied, wherein the access criteria of the customer assistance and/or customer review service comprises spatial criteria related to the location of the business operation, and wherein said determining if the access criteria of the customer assistance and/or customer review service is satisfied comprises determining if a location of the computing device satisfies the spatial criteria related to the location of the business operation; and allowing, by the processing system, the computing device to access the customer assistance and/or customer review service if it is determined that the access criteria of the customer assistance and/or customer review service is satisfied.

In at least some embodiments, said business operation has business hours at the location of the business operation; the access criteria of the customer assistance and/or customer review service further comprises temporal criteria related to the business hours of the business operation at the location of the business operation; and said determining if the access criteria of the customer assistance and/or customer review service is satisfied comprises determining if the location of the computing device satisfies the spatial criteria related to the location of the business operation and determining if the temporal criteria related to the business hours of the business operation is satisfied.

In at least some embodiments, said determining if the temporal criteria related to the business hours of the business operation is satisfied comprises determining if a time of day at which the message is received satisfies the temporal criteria related to the business hours of the business operation.

In at least some embodiments, said request included in said message from the computing device comprises a request from a user of the computing device for customer assistance from an associate of the business operation.

In at least some embodiments, said request included in said message from the computing device comprises a request from a user of the computing device to provide a review by a user of the computing device in regard to the business operation.

In at least some embodiments, said request included in said message from the computing device comprises a request from a user of the computing device for a telephone call to request help from an associate of the business operation.

In at least some embodiments, said determining if a location of the computing device satisfies spatial criteria related to the location of the business operation comprises: receiving global positioning system (GPS) coordinates indicative of the location of computing device; and determining if the GPS coordinates are within a specified range of the location of the business operation.

In at least some embodiments, said allowing the computing device to access the customer assistance and/or customer review service associated with the business operation if it is determined that the access criteria of the customer assistance and/or customer review service is satisfied comprises: activating a feature in the processing system to allow interactive communication between a user of the computing device and an associate of the business operation if it is determined that the access criteria of the customer assistance and/or customer review service is satisfied.

In at least some embodiments, said activating a feature in the processing system to allow interactive communication between a user of the computing device and a store associate comprises: defining a view that is displayable on the computing device and includes one or more user interface elements to allow a user of the computing device to choose one or more pre-programmed statements and/or questions to send to a computing device of an associate of the business operation, or allowing said user to customize his or her statements and/or questions; and defining a view that is displayable on the computing device of the associate of the business operation and includes one or more user interface elements to allow the associated of the business operation to choose one or more pre-programmed responses to send to the computing device of the user.

In at least some aspect, at least one non-transitory computer readable storage medium stores processor-executable instructions that, when executed by at least one processor, result in a method comprising: receiving a message from a computing device, the message including a request for assistance and/or to provide a review relating to a business operation at a location; determining if access criteria of a customer assistance and/or customer review service associated with the business operation at the location is satisfied, wherein the access criteria of the customer assistance and/or customer review service comprises spatial criteria related to the location of the business operation, and wherein said determining if the access criteria of the customer assistance and/or customer review service is satisfied comprises determining if a location of the computing device satisfies the spatial criteria related to the location of the business operation; and allowing the computing device to access the customer assistance and/or customer review service if it is determined that the access criteria of the customer assistance and/or customer review service is satisfied.

In at least some aspects, apparatus comprises: a processing system to: receive a message from a computing device, the message including a request for assistance and/or to provide a review relating to a business operation at a location; determine if access criteria of a customer assistance and/or customer review service associated with the business operation at the location is satisfied, wherein the access criteria of the customer assistance and/or customer review service comprises spatial criteria related to the location of the business operation, and wherein said determine if the access criteria of the customer assistance and/or customer review service is satisfied comprises determining if a location of the computing device satisfies the spatial criteria related to the location of the business operation; and allow the computing device to access the customer assistance and/or customer review service if it is determined that the access criteria of the customer assistance and/or customer review service is satisfied.

This Summary is intended to provide an overview of at least some of the subject matter of the present patent application. It is not intended to provide an exclusive or exhaustive explanation of the invention or embodiments thereof.

Thus, while certain aspects and embodiments have been presented and/or outlined in this Summary, it should be understood that the present aspects and embodiments are not limited to the aspects and embodiments in this Summary. Indeed, other aspects and embodiments, which may be similar to and/or different from, the aspects and embodiments presented in this Summary, will be apparent from the description, illustrations and/or claims, which follow.

Further limitations and disadvantages of conventional and traditional approaches will become apparent to one of skill in the art, through comparison of such systems with some aspects of the present invention as set forth in the remainder of the present application with reference to the drawings.

However, while various features and/or advantages are described in this Summary and/or will become apparent in view of the following detailed description and accompanying drawings, it should be understood that such features and/or advantages are not required in all aspects and embodiments.

Any aspects and/or embodiments that are described in this Summary and do not appear in the claims that follow are preserved for later presentation in this application or in one or more continuation patent applications. Any aspects and/or embodiments that are not described in this Summary and do not appear in the claims that follow are also preserved for later presentation or in one or more continuation patent applications.

### BRIEF DESCRIPTION OF THE DRAWINGS

Reference is made to the following detailed description in connection with the accompanying drawings, in which:

FIG. 1 illustrates an exemplary software-generated interface through which users can identify themselves as customers or as existing team members, in accordance with at least some embodiments;

FIG. 2 illustrates a “sign in” screen interface through which a user can authenticate themselves, in accordance with at least some embodiments;

FIG. 3 illustrates an exemplary listing interface of retailers and restaurants, in accordance with at least some embodiments;

FIG. 4 illustrates an exemplary location detail screen, showing a retailer as selected by the user, in accordance with at least some embodiments;

FIG. 5 illustrates another exemplary interface screen on a customer device and app, in accordance with some embodiments;

FIG. 6 illustrates another exemplary interface on a retail store associate's device and app, in accordance with at least some embodiments;

FIG. 7 illustrates an exemplary admin interface whereby a manager can monitor communications between team members and customers, and other information, in accordance with at least some embodiments;

FIG. 8 illustrates another view of a retail associate app interface, in accordance with at least some embodiments;

FIG. 9 illustrates an exemplary manager or administrator dashboard interface, in accordance with at least some embodiments;

FIG. 10 illustrates another view, in accordance with at least some embodiments;

FIG. 11 illustrates another view, in accordance with at least some embodiments;

FIG. 12 illustrates another exemplary screen or dashboard, in accordance with at least some embodiments;

FIG. 13 is a flowchart of a method, in accordance with at least some embodiments;

FIG. 14 is a flowchart of a method, in accordance with at least some embodiments;

FIG. 15 is a block diagram of an architecture of a processing system, in accordance with some embodiments;

FIG. 16 is a flowchart of a method, in accordance with at least some embodiments;

FIG. 17 is a flowchart of a method, in accordance with at least some embodiments;

FIG. 18 shows a computing device, in accordance with at least some embodiments;

FIG. 19 is a flowchart of a method, in accordance with at least some embodiments;

FIG. 20 is a flowchart of a method, in accordance with at least some embodiments;

FIG. 21 is a flowchart of a method, in accordance with at least some embodiments;

FIG. 22 is a flowchart of a method, in accordance with at least some embodiments;

FIG. 23 is a flowchart of a method, in accordance with at least some embodiments;

FIG. 24 is a flowchart of a method, in accordance with at least some embodiments;

FIG. 25 shows a computing device, in accordance with at least some embodiments;

FIG. 26 is a diagram showing an architecture and a data flow, in accordance with at least some embodiments;

FIG. 27 is a diagram showing an architecture and a data flow, in accordance with at least some embodiments;

FIG. 28 is a diagram showing an architecture and a data flow, in accordance with at least some embodiments;

FIG. 29 is a diagram showing an architecture and a data flow, in accordance with at least some embodiments; and

FIG. 30 is a block diagram of an architecture, in accordance with at least some embodiments.

### DETAILED DESCRIPTION

The present disclosure is generally directed to computer-enabled communications and applications so as to assist retailers, retail associates and retail customers; as well as to assist full service restaurants, restaurant servers and restaurant patrons. At a high level, an architecture is provided including a server platform, mobile client device, communication infrastructure, and machine-readable instructions or program code installed thereon and running in suitable processing circuits therein.

In a multi-party retail environment, several parties may employ the present system and method, each through a suitable device or interface. For instance, a retailer (organization, manager) may use a computer-based interface to log in to a management application to as to control settings of the application, data available to and from the application, and to receive updates and status information relating to the operation of his or her retail store or chain of stores. A customer may employ on his or her mobile device, e.g., a smartphone, a special application (app) provided through which the customer can call or send requests for assistance at the store or other information and feedback regarding their shopping experience. A store associate (on duty clerk) may further employ a mobile device to receive customer requests for assistance and to render answers or other information to the system.

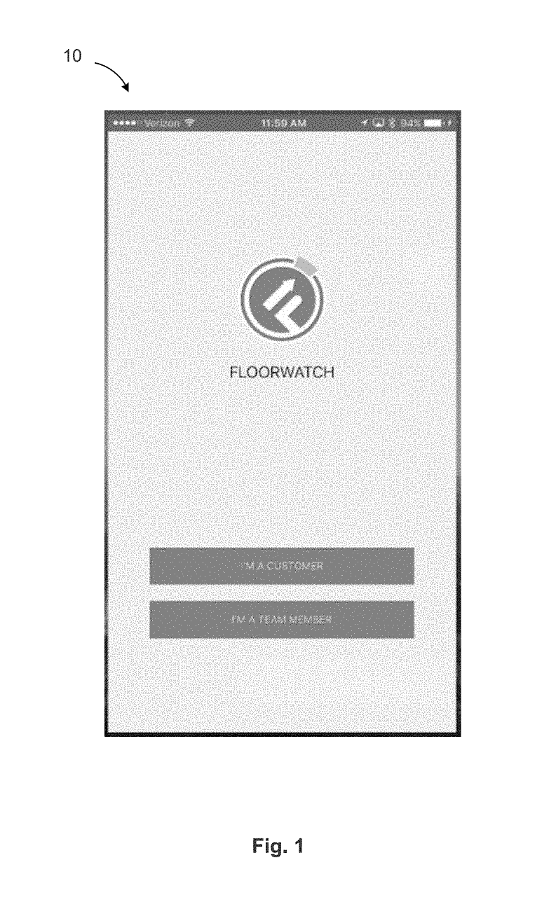

FIG. 1 illustrates an exemplary software-generated interface 10 through which users can identify themselves as customers or as existing team members. This can be done in a computer-based interface by clicking, touching, tapping, swiping or otherwise directing an input to the software interface so that the underlying application can direct the next screens to display options appropriate for customers or team members, respectively.

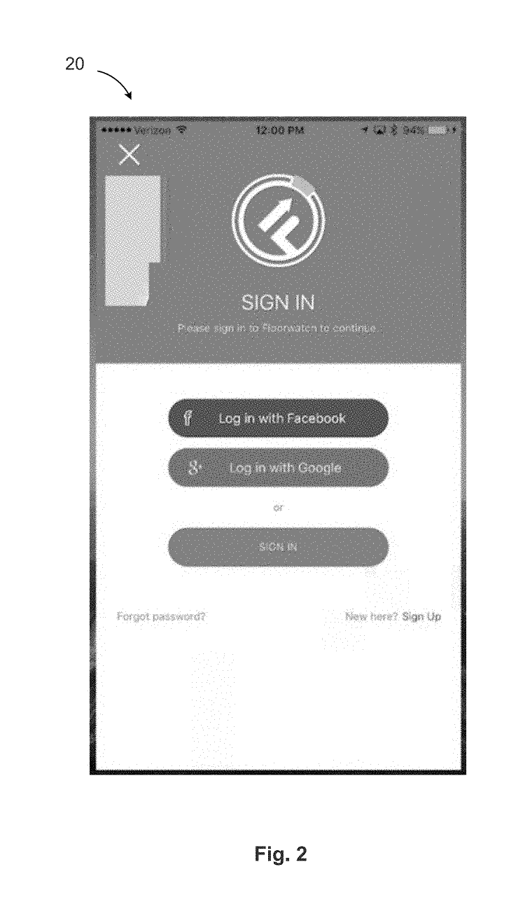

FIG. 2 illustrates a “sign in” screen interface 20 (again, which can be presented on a computer, tablet or mobile device) and through which a user can authenticate themselves to the system, e.g., by entering user name and password data, or by authentication through an existing social media account coupled to the application interface. A new user may create an account as appreciated by those skilled in the art, after which the new user can log in according to the authentication information created during the establishment of the new account.

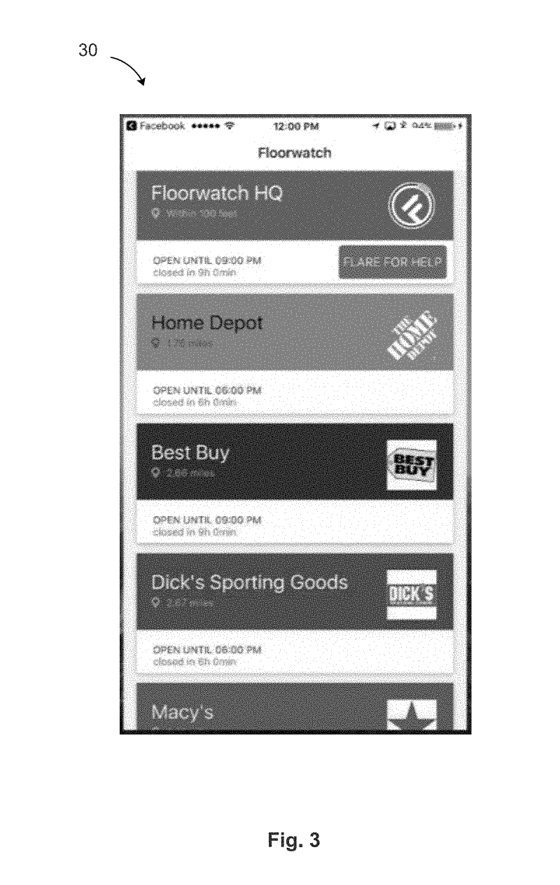

FIG. 3 illustrates an exemplary listing interface 30 of retailers and restaurants who may be participating in the present system and method, or whose information is available to the system (e.g., in a database, online lookup, etc.). A user of the interface 30 can scroll through the list of retailers and select one by choosing the retailer, e.g., by clicking or otherwise indicating the desired choice in the available interface commands. It should be appreciated that the examples presented herein are merely for the sake of illustration and are not intended to be limiting or exhaustive. Those skilled in the art will appreciate many equivalent or alternative implementations consistent with this disclosure, all of which are intended to be covered hereby.

The list presented in FIG. 3 may be generated according to any suitable methodology. For example, the list may be sorted according to retailers and/or restaurants in ascending order of geographic distance from the user (or more particularly, the user's device). This would call for location services to be available in the user's device so that a server can be updated regarding the device's real time location. The server can then calculate the distance from the user, based on the user's global positioning (GPS) coordinates, address, IP location or other positioning information. In another example, the list may be sorted according to a user's indicated profile, a search criterion, or user preferences. In yet another example, the list may be sorted based on an existing commercial relationship, sponsorship or other business arrangement between one or more parties.

In at least some embodiments, the mobile application may receive global positioning system (GPS) coordinates that indicate the location of the computing device of the customer, and the mobile application may then use the GPS coordinates to obtain (from a web server API) the list of locations.

The interface 30 may swipe down to present a search field, where the user can enter a query term or parameters to filter the list of locations using its name. In at least some embodiments, this may be expanded to allow search by an address (e.g., city/zip), location type (e.g., store, restaurant), range from user's device (i.e., distance), and/or location status (i.e., open now).

Also, the interface 30 may present some basic information about each listed retailer. For example, the display may include the nearest store's address, distance from the user, hours of operation, main phone number, URL of the store's web page, and so on. Additionally, basic marketing graphics, logos or other identification information can be presented in interface 30.

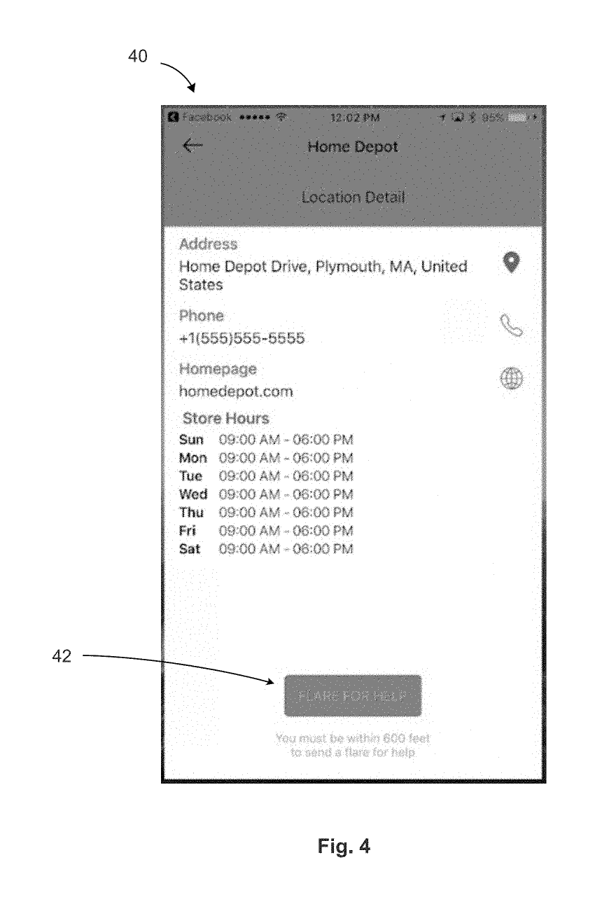

FIG. 4 illustrates an exemplary location detail screen 40, showing a retailer as selected by the user from the earlier interfaces. The name and basic location, phone, web and other contact information of the retailer or restaurant, as well as detailed business hours, can be displayed for convenience. Again, the particular store or restaurant location may be chosen based on proximity to the user or other factors. The location detail information can be input to the system and stored in a data store, computer memory device, etc. and may be input by a manager or administrator of the retailer having an account in the system. Alternatively, the data may be imported from a public or private database, e.g., phone directory listing, online information, or other source.

In an embodiment, a user (e.g., a customer) within the geographic range may use the present system and method to call the store or send a request for assistance from a team member, also using the application within the geographic range. The customer, using the app running on his or her mobile device can select or press a button or other user interface element to summon assistance. The screen 40 may for example provide a touch-sensitive element (soft button) 42 as shown in this example and pressing the button 42 would send a signal from the customer's device to a server to initiate an assistance interaction event. In an aspect, the customer must be physically within a specified range of the retail store to enable the call for help, which in one present example is referred to as a “Flare”. For instance, the system may be configured so that the customer must be within 600 feet of the retail location as determined by whichever location-sensing means are used to identify the user's location (GPS, network towers, beacons, or other). It will be appreciated that these examples are merely illustrative, and any other reasonable radius, diameter, range or geo-fence box may be programmed to limit users from attempting to summon assistance at a store they are deemed too remote from. Preferably, a customer is determined to be proximal in the store/restaurant location in order for them to initiate a phone call to the store/restaurant; or activate “Flare” calls for in-store/on-site assistance.

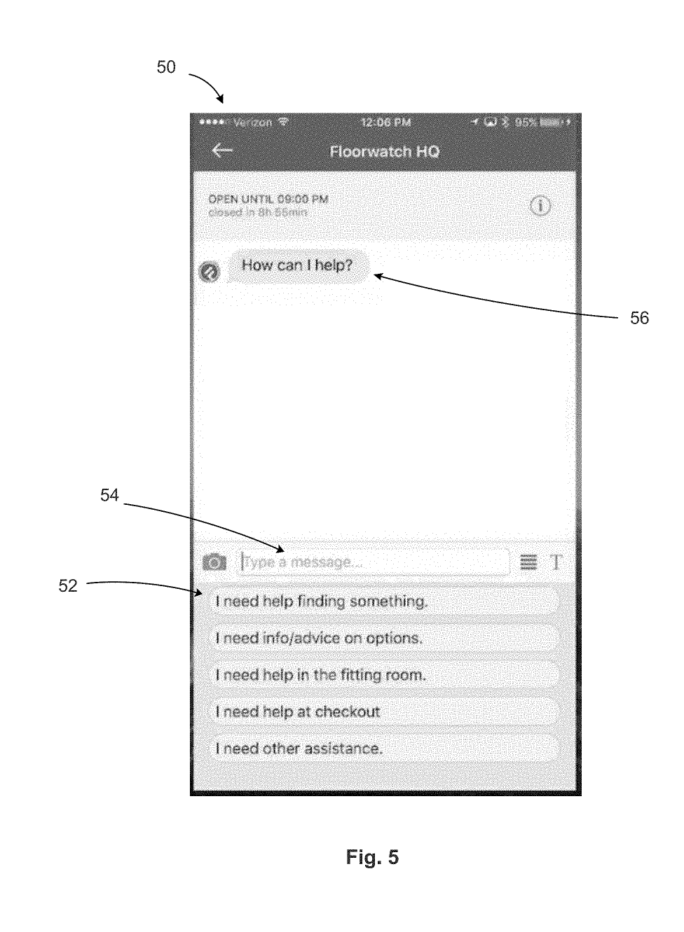

FIG. 5 illustrates another exemplary interface screen 50 on a customer device and app, showing sample pre-programmed statements or questions 52. These pre-programmed statements 52 may be chosen based on the most common or expected requests that customers are known to have and can be a convenience aid in using the app. The customer can alternatively type a custom request into a text input box 54. The customer's request is sent as a message over a wireless communication network and through a server to the appropriate party (e.g., a store associate) to receive the request for assistance. The messages from the store manager or associate are displayed as 56 on screen 50, which in some examples can look similar to a traditional messaging application interface.

In at least some embodiments, the pre-programmed statements may be stored in a database. The database may have any suitable form(s). In at least some embodiments, the database may comprise one or more tables (with at least some of the pre-programmed statements) and/or pre-defined rules that can be used to choose, generate or otherwise define, at least some of the pre-programmed statements.

FIG. 5 also presents the customer an opportunity to rate the experience at the conclusion of a session, whether the session is ended by the expiration of time or by the consumer device leaving the geo-fenced location. The question asks, “Did you get the help you needed?” and prompts a response that is captured in reports and relayed back to the team member. It then asks the customer to rate this experience while in the store/restaurant, using one to five stars, which is captured in reports and relayed back to the team member who responded. Finally, a field for comments is presented when the consumer had answered they received assistance, which is captured in reports, but are not relayed back to the team member.

In at least some embodiments, the mobile application(s) have two different functionality flows, one for each of the two different types of users (customer and team member).

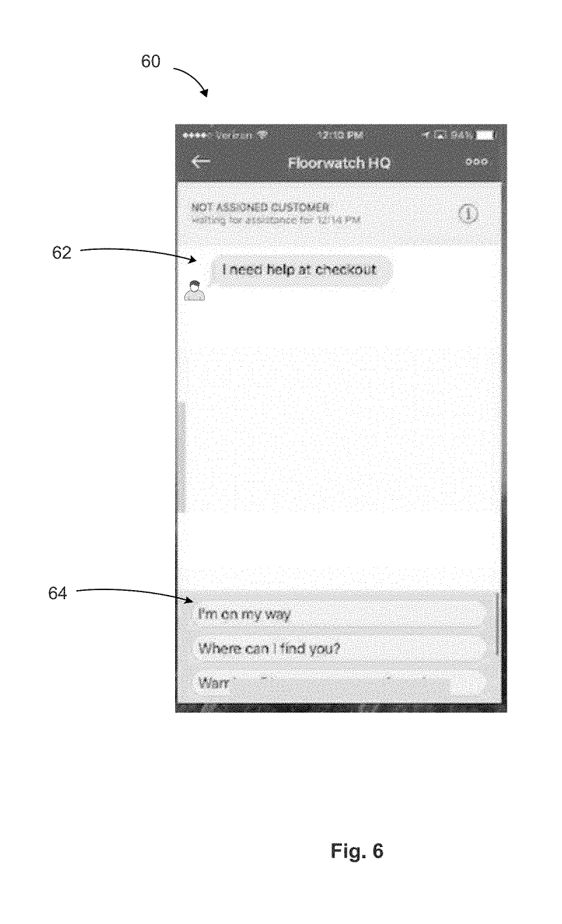

FIG. 6 illustrates another exemplary interface 60 on a retail store associate's device and app, wherein the associate receives the request 62 from the customer, and is prompted to select a suitable response 64, which is relayed back to the customer. In one embodiment, which is not limiting, the team member is only allowed to reply using pre-programmed responses 64 from a list of such responses. These pre-programmed responses may be set by the manager or administrator of the retail store's account in the present system. If more than one associate are on duty in a store at the time of receiving a Flare help request, the request can be claimed by an associate by pressing a response button on his or her device indicating that he or she intends to attend to the need of the customer. In an optional aspect, a store associate can forward the Flare to another on-duty associate for handling.

In at least some embodiments, the pre-programmed responses may be stored in a database. The database may have any suitable form(s). In at least some embodiments, the database may comprise one or more tables with pre-programmed responses. In at least some embodiments, the database may comprise pre-defined rules that can be used to choose, generate or otherwise define, the pre-programmed responses.

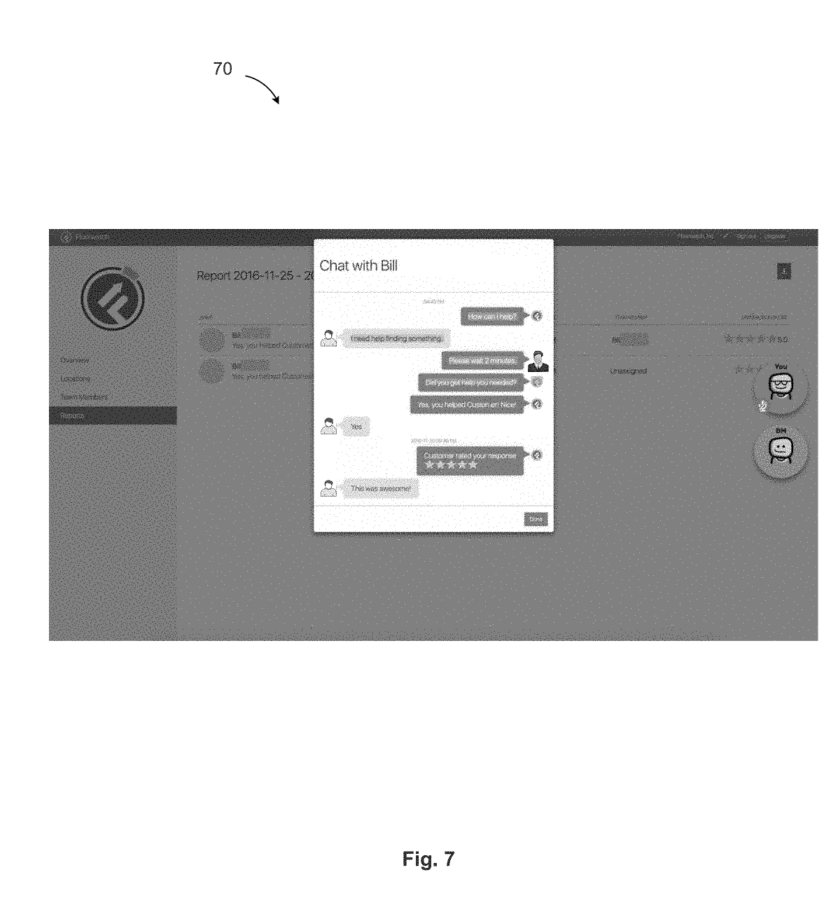

As mentioned above, a manager or administrator account is created, which allows management and customization of a retailer's account in the present context. FIG. 7 illustrates an exemplary admin interface 70 whereby a manager can monitor communications between team members and customers, and other information.

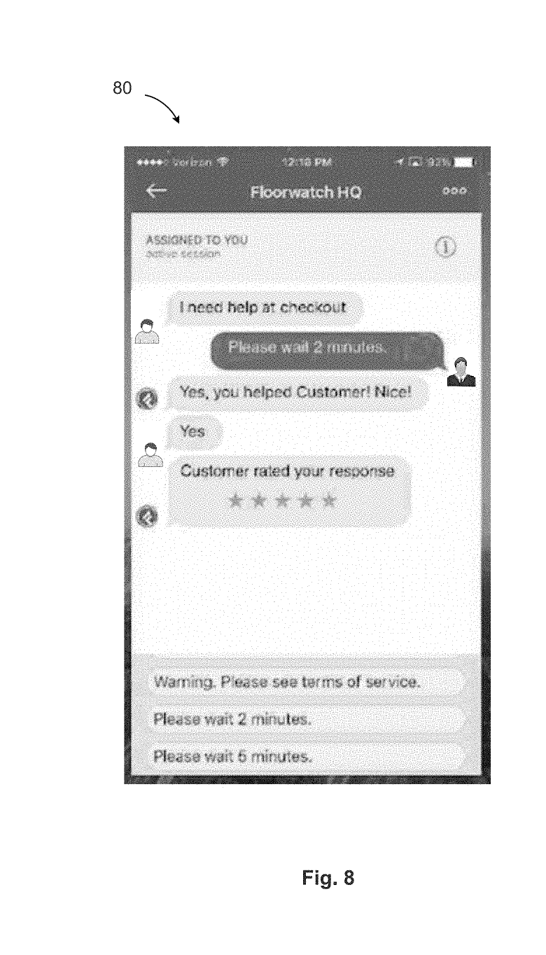

FIG. 8 illustrates another view of a retail associate app interface 80. Here, the associate sees a summary of the exchange with the customer, and can further see the results of the interaction with the customer if the customer provided feedback on their experience with the associate. In the example shown, the customer rated the responsiveness to their Flare help request as five-stars. Those skilled in the art will appreciate that many other types of feedback and formats can be used instead of the one shown here for illustration.

As aspect of the present system may include the notion of time limits or a time-out. A maximum pre-set time limit may be allocated for an associate to claim or to respond to a customer's Flare help request.

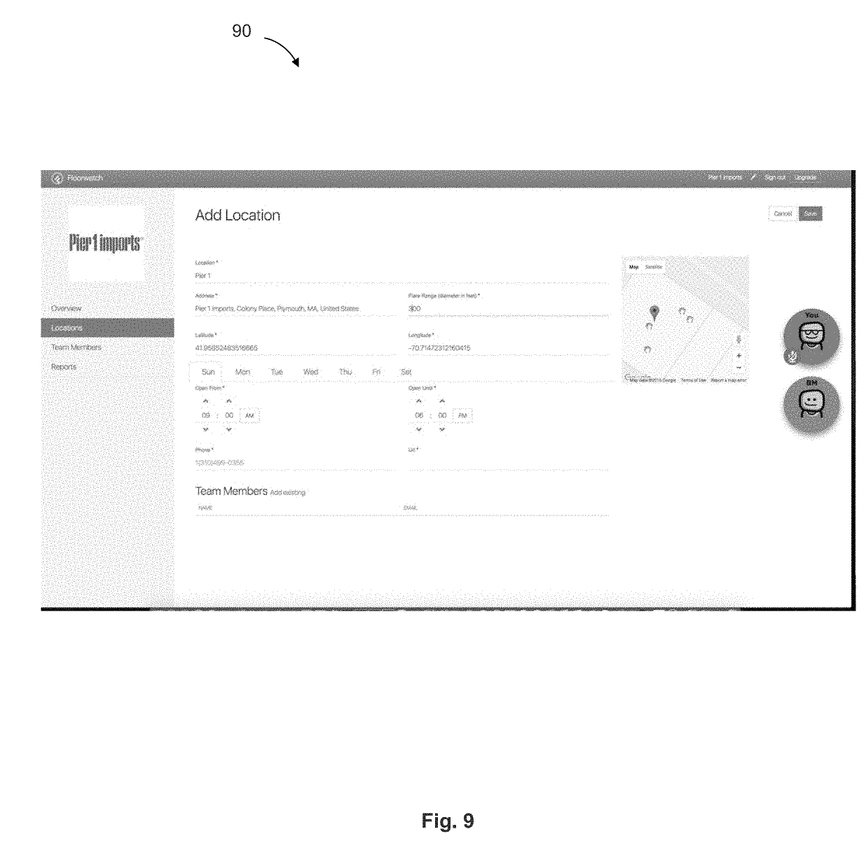

FIG. 9 illustrates an exemplary manager or administrator dashboard interface 90, which can be used to input various details about a retail store, for example when adding a new store location to a database of stores. The dashboard can be configured to set a store's hours, e.g., with a common calendar type interface, or to set the precise map location of a store, e.g., using a common mapping type interface, or to add team members who serve as store associates, their respective on-duty schedules, etc. In addition, the administrator can use this dashboard to pre-set the distance, diameter or radius of a geo-fence outside of which customer Flare help requests should not be enabled.

In yet another embodiment, the system and method determine the location of a customer's mobile device on which the present app is installed and operating. The system and method can also determine whether the customer is at a retailer who is a member or subscriber to the present services. If the retailer is not a member and is not participating in the present service enabling the present Flare help messaging, then the system substitutes a Call button for the Flare help button on the customer app. This in effect causes the app to offer a minimal level of assistance to the customer whereby the customer with a single press of a button on his or her screen is put through over a telephone connection to the store location's listed telephone number. A store telephone operator can then assist or forward the customer as needed and as customary in such circumstances.

In an aspect, a store associate may be geo-fenced similar to how a customer is geo-fenced, above. That is, the system and method can be programmed to only involve store associates whose location (based on a location of their mobile devices) shows them to be on-premises, or on duty. This geo-fencing can be based on a range or radius measured from the store location to the associate's device, or vice versa.

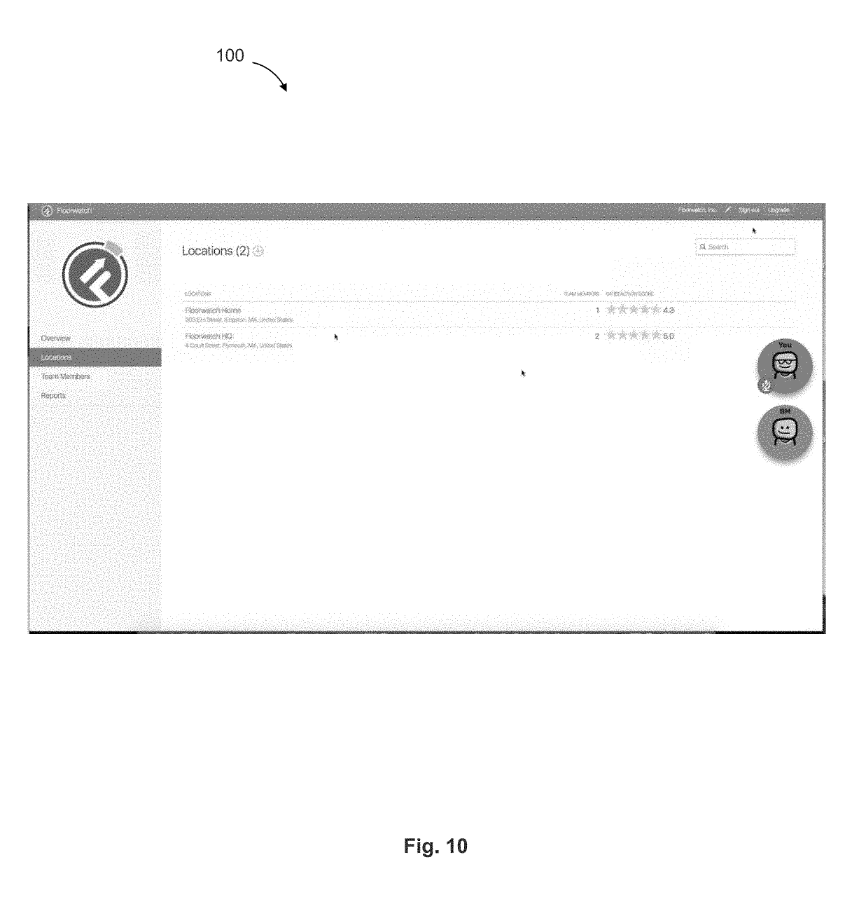

Many other views, dashboards and interface screens can be designed as required by a given implementation. Those shown herein are merely for the sake of illustrating the present concepts and are not limiting. For example, FIG. 10 illustrates a view 100 allowing an administrator or manager to see the list of stores under his or her account, and a brief summary of the stores' performance as measured by the ratings or reviews offered by customers after a Flare help interaction. This view is also designed to allow the manager to add a new store location by clicking on the “+” symbol near the store locations heading.

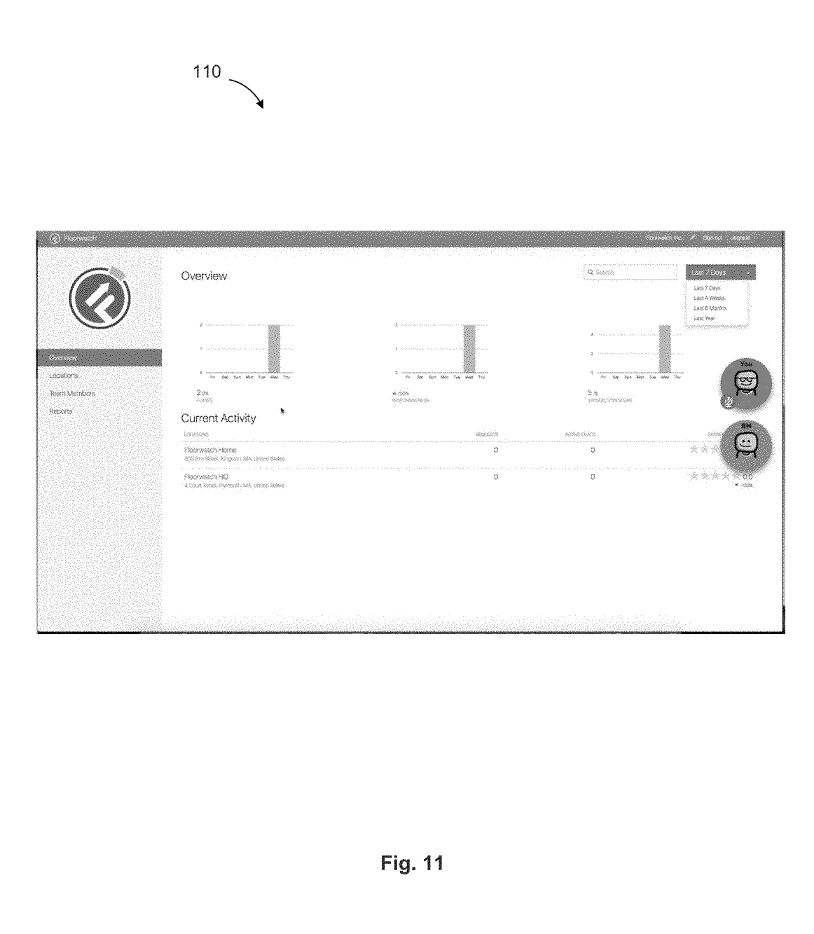

In the same spirit, FIG. 11 illustrates an exemplary view 110 of a manager or administrative dashboard showing the number and/or performance of various parties in the system and method. In an instance, the activity and/or performance of a store can be shown on a graphical interface, in another instance, the performance and/or activity of one or more associates can be summarized. In yet another instance, current (real time) activity using the system and method can be displayed.

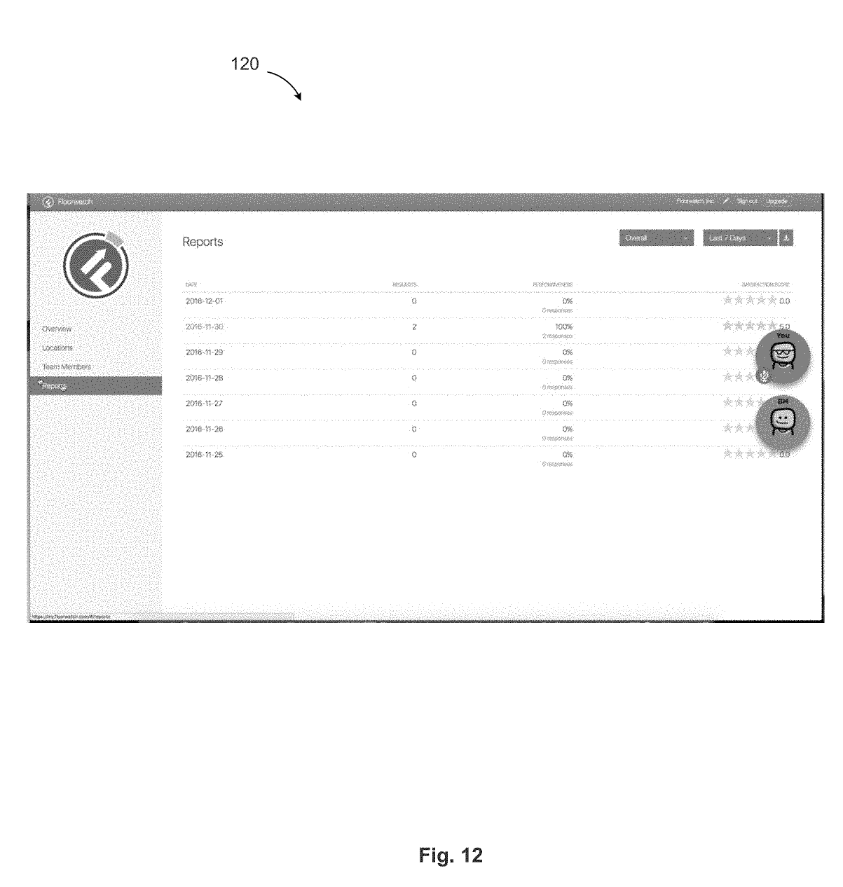

Finally, FIG. 12 illustrates yet another exemplary screen or dashboard 120 showing Flare help request and response statistics for some account, sorted by date or location. These and other features can be optionally added to the present system and method as may be fit for a given application, such as statistics by team member, time of day, etc.

Thus, at least some aspects disclosed herein provide technological processes to further assist customers and/or other parties.

These technological processes are a significant improvement over any current technological processes that assist customers and/or other parties.

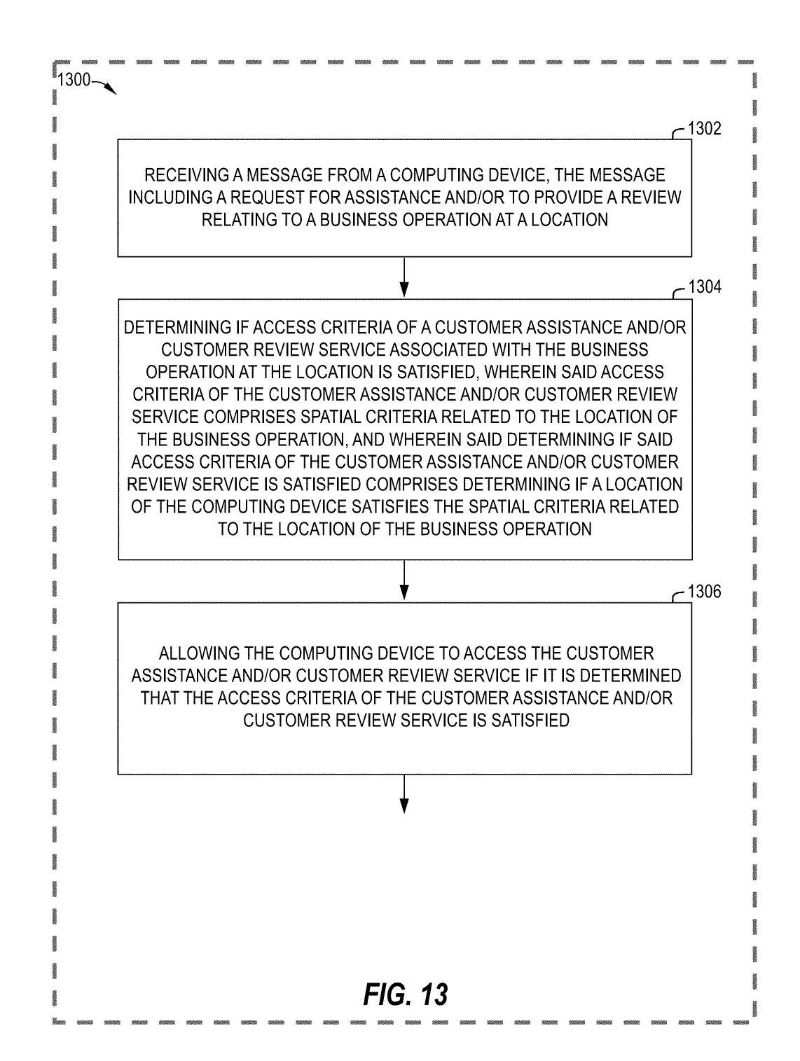

FIG. 13 is a flowchart of a method 1300, in accordance with at least some embodiments.

In at least some embodiments, the method (or one or more portion(s) thereof) may be performed by one or more of the systems or portions thereof, described above.

The method is not limited to the order shown, but rather may be performed in any practicable order. For that matter, any method disclosed herein is not limited to any particular order but rather may be performed in any practicable order.

One or more portions of the method may be used without one or more other portions of the method. For that matter, one or more portions of any method (or system) disclosed herein may be used without one or more other portions of such method (or system).

In at least some embodiments, the method (or one or more portion(s) thereof) may be performed using one or more portions of one or more other methods disclosed herein. For that matter, in at least some embodiments, any method (or one or more portions thereof) disclosed herein may be performed using one or more portions of one or more other methods disclosed herein.

In at least some embodiments, the method (or one or more portion(s) thereof) may be performed in performance of one or more portions of one or more other methods disclosed herein. For that matter, in at least some embodiments, any method (or one or more portions thereof) disclosed herein may be performed in performance of one or more portions of one or more other methods disclosed herein.

Referring to FIG. 13, at 1302, the method may include receiving a message from a computing device, the message including a request for assistance and/or to provide a review relating to a business operation at a location.

In at least some embodiments, the message and request may have any form(s) and may be received in any manner(s) (directly and/or indirectly) from any source(s).

In at least some embodiments, said request included in said message from the computing device comprises a request from a user of the computing device for customer assistance from an associate of the business operation.

In at least some embodiments, said request included in said message from the computing device comprises a request from a user of the computing device to provide a review by a user of the computing device in regard to the business operation.

In at least some embodiments, said request included in said message from the computing device comprises a request from a user of the computing device for a telephone call to request help from an associate of the business operation.

In at least some embodiments, the business operation may comprise any type of business operation.

In at least some embodiments, the business operation may comprise a restaurant business and/or a retail business and/or a hotel or similar lodging business.

In at least some embodiments, the business operation may be located within one or more buildings at the location.

At 1304, the method may further include determining if access criteria of a customer assistance and/or customer review service associated with the business operation at the location is satisfied, wherein the access criteria of the customer assistance and/or customer review service comprises spatial criteria related to the location of the business operation, and wherein said determining if access criteria of the customer assistance and/or customer review service is satisfied comprises determining if a location of the computing device satisfies the spatial criteria related to the location of the business operation.

In at least some embodiments, the request included in the message may comprise a request to access the customer assistance and/or customer review service associated with the business operation.

In at least some embodiments, determining if a location of the computing device satisfies the spatial criteria related to the location of the business operation may comprise determining if the computing device is within a specified range of the location of the business operation.

In at least some embodiments, determining if a location of the computing device satisfies spatial criteria related to the location of the business operation comprises: receiving global positioning system (GPS) coordinates indicative of the location of computing device; and determining if the GPS coordinates are within a specified range of the location of the business operation.

In at least some embodiments, the access criteria cannot be satisfied if it is determined that the spatial criteria is not satisfied.

In at least some embodiments, the spatial criteria may be satisfied only if the computing device is located in a specified portion of the location of the business operation. In at least some of such embodiments, the business operation may be in a building at the location and the spatial criteria may be satisfied only if the computing device is in the building and/or only if the computing device is located in one of one or more specified locations (e.g., a particular aisle or aisles) within the building.

However, the spatial criteria may have any form and is not limited to the above.

In at least some embodiments, if it is determined that the spatial criteria is not satisfied, the method may not proceed but rather may continue to perform such determination until it is determined that the spatial criteria is satisfied.

At 1306, the method may further include allowing the computing device to access the customer assistance and/or customer review service if it is determined that the access criteria of the customer assistance and/or customer review service is satisfied.

In at least some embodiments, this may comprise activating a feature in the processing system to allow interactive communication between a user of the computing device and an associate of the business operation if it is determined that the access criteria of the customer assistance and/or customer review service is satisfied.

In at least some embodiments, the interactive communication may comprise interactive communication via graphical user interfaces. In at least some embodiments, such communication may comprise a flare from the computing device of the user and a response from the computing device of the associate. In addition, the associate may determine if the user requires assistance in person, and if so, the associate may meet and assist the user in person in the location of the business operation.

In at least some embodiments, the interactive communication may comprise a telephone call. The associate may answer the incoming call and assist the user of the computing device by phone. In addition, the associate may determine if the user requires assistance in person, and if so, the associate may meet and assist the user in person in the location of the business operation.

In at least some embodiments, activating a feature in the processing system to allow interactive communication between a user of the computing device and an associate of the business operation may comprise defining a view that is displayable on the computing device and includes one or more user interface elements to allow a user of the computing device to choose one or more pre-programmed statements and/or questions to send to a computing device of an associate of the business operation, or allowing said user to customize his or her statements and/or questions; and defining a view that is displayable on the computing device of the associate of the business operation and includes one or more user interface elements to allow the associated of the business operation to choose one or more pre-programmed responses to send to the computing device of the user.

In at least some embodiments, the business operation may have business hours at the location and the access criteria of the customer assistance and/or customer review service may further comprise temporal criteria related to the business hours of the business operation at the location.

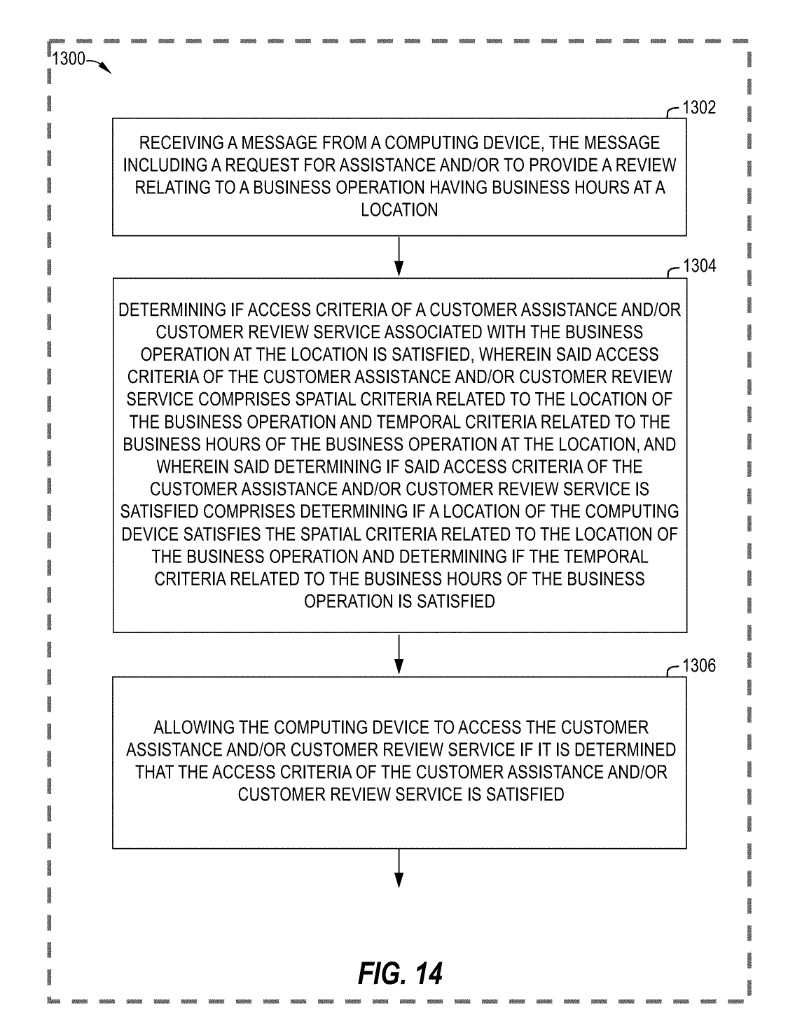

FIG. 14 is a flowchart of an embodiment of the method 1300, in which the business operation has business hours at the location and the access criteria of the customer assistance and/or customer review service further comprises temporal criteria related to the business hours of the business operation at the location, in accordance with at least some embodiments.

At 1302, the method may include receiving a message from a computing device, the message including a request for assistance and/or to provide a review relating to a business operation having business hours at a location.

At 1304, the method may further include determining if access criteria of a customer assistance and/or customer review service associated with the business operation at the location is satisfied, wherein the access criteria of the customer assistance and/or customer review service comprises spatial criteria related to the location of the business operation and temporal criteria related to the business hours of the business operation at the location, and wherein determining if the access criteria of the customer assistance and/or customer review service is satisfied comprises determining if the location of the computing device satisfies the spatial criteria related to the location of the business operation and determining if the temporal criteria related to the business hours of the business operation is satisfied.

In at least some embodiments, said determining if the temporal criteria related to the business hours of the business operation is satisfied comprises determining if a time of day at which the message is received satisfies the temporal criteria related to the business hours of the business operation.

In at least some embodiments, the temporal criteria related to the business hours may be satisfied only if the message is received within the business hours, within a subset of the business hours and/or within specified hours before and/or after the business hours. The latter may be desirable, for example, if a customer entered a store location prior to closing, but is still in the store location after closing and needs additional assistance prior to proceeding to a check-out counter.

However, the temporal criteria may have any form and is not limited to the above.

In at least some embodiments, the access criteria cannot be satisfied if it is determined that the spatial criteria and/or the temporal criteria is not satisfied.

In at least some embodiments, the method may determine if the location of the computing device satisfies the spatial criteria prior to determining if the temporal criteria is satisfied. In at least some of such embodiments, if it is determined that the spatial criteria is not satisfied, the method may not proceed but rather may continue to perform such determination until it is determined that the spatial criteria is satisfied. Thereafter, if it is determined that the temporal criteria is not satisfied, the method may not proceed but rather may continue to perform such determination until it is determined that the temporal criteria is satisfied.

At 1306, the method may further include allowing the computing device to access the customer assistance and/or customer review service if it is determined that the access criteria of the customer assistance and/or customer review service is satisfied.

Other embodiments may also be employed.

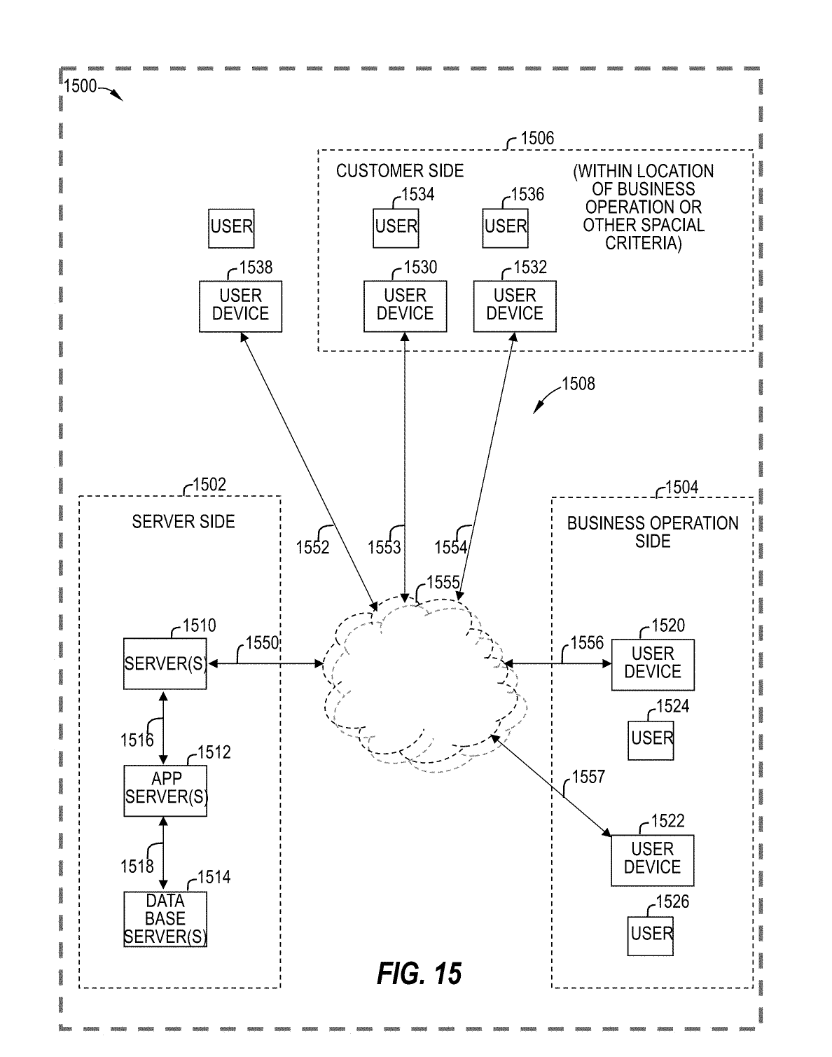

FIG. 15 is a block diagram of an architecture of a processing system 1500, in accordance with some embodiments.

In at least some embodiments, one or more of the methods (or portion(s) thereof) disclosed herein may be performed by the processing system 1500.

Referring to FIG. 15, the processing system 1500 may include a server side 1502, a business operation side 1504, a customer side 1506, and a communication infrastructure 1508 (a plurality of communication links) that couple the server side 1502, business operation side 1504 and customer side 1506 to one another.

The server side 1502 may include one or more server(s) (local and/or remote) and one or more database(s) coupled via one or more communication links. In the illustrated embodiment, the server side 1502 includes one or more web servers 1510, one or more app servers 1512 and one or more database servers 1514 coupled by communication links 1516-1518. Each server may include one or more processors that perform one or more tasks. One or more of the processors may execute one or more programs in performing one or more of such tasks. Each database may store information collected and/or used by the processing system 1500.

The business operation side 1504 may include one or more user devices, e.g., user devices 1520-1522, which may be operated by one or more users, e.g., users 1524-1526. The one or more user devices may comprise any type(s) of user devices. In at least some embodiments, one or more of the user devices, e.g., user device 1520, may comprise a desktop computer and may be operated by an owner or other representative, e.g., user 1524, of the business operation. Such user device(s) may include one or more processors that perform one or more tasks. One or more of the processors may execute one or more programs in performing one or more of such tasks. One or more of the programs may comprise a web-client and/or may provide an administrative dashboard for the user.

One or more of the user devices, e.g., user device 1522, may comprise a mobile computing device and may be operated by an associate, e.g., user 1526, responsible for providing assistance to customers in the location of the business operation.

Each customer device may include one or more processors, one or more input devices, and one or more output devices. The one or more processors, may communicate with the input devices and the output devices in order to provide user interfaces. The one or more processors may perform one or more tasks. One or more of the processors may execute one or more programs in performing one or more of such tasks. One or more of the programs may comprise an application, sometimes referred to herein as a mobile application, that communicates with the server side 1502, which the associate of the business operation may use to provide assistance to a customer.

The customer side 1506 may include one or more user devices, e.g., user devices 1530-1532, sometimes referred to herein as customer devices, which may be operated by one or more users, e.g., users 1534-1536, sometimes referred to herein as customers. The one or more customer devices, e.g., 1530-1532, may be located within a location of a business operation or other spatial criteria and allowed to access a customer assistance and/or customer review service. One or more other user devices, e.g., user device 1538, may be outside the location of the business operation or other special criteria and not allowed to access the customer assistance and/or customer review service.

One or more of the customer devices, e.g., customer devices 1530-1532, may comprise a smart phone and/or other type of mobile computing device. Each customer device may include one or more processors, one or more input devices, and one or more output devices. The one or more processors, may communicate with the input devices and the output devices in order to provide user interfaces. The one or more processors may execute one or more programs to perform one or more tasks. One or more of such programs may comprise an application, sometimes referred to herein as a mobile application, that communicates with the server side 1502 to request assistance from an associate of the business operation and/or to provide a review of the business operation. In at least some embodiments, the application may comprise an IOS client application or an ANDROID client application. In at least some embodiments, the application may include a geo-fencing module.

The communication infrastructure 1508 may comprise a plurality of communication links, e.g., communication links 1550-1557, that couple the server side 1502, business operation side 1504 and customer side 1506 to one another. One or more of the communication links may define a network (or a portion thereof), e.g., a local area network and/or a wide area network, e.g., the Internet.

As stated above, the present disclosure is generally directed to computer-enabled communications and applications so as to assist retailers, retail associates and retail customers; as well as to assist full service restaurants, restaurant servers and restaurant patrons.

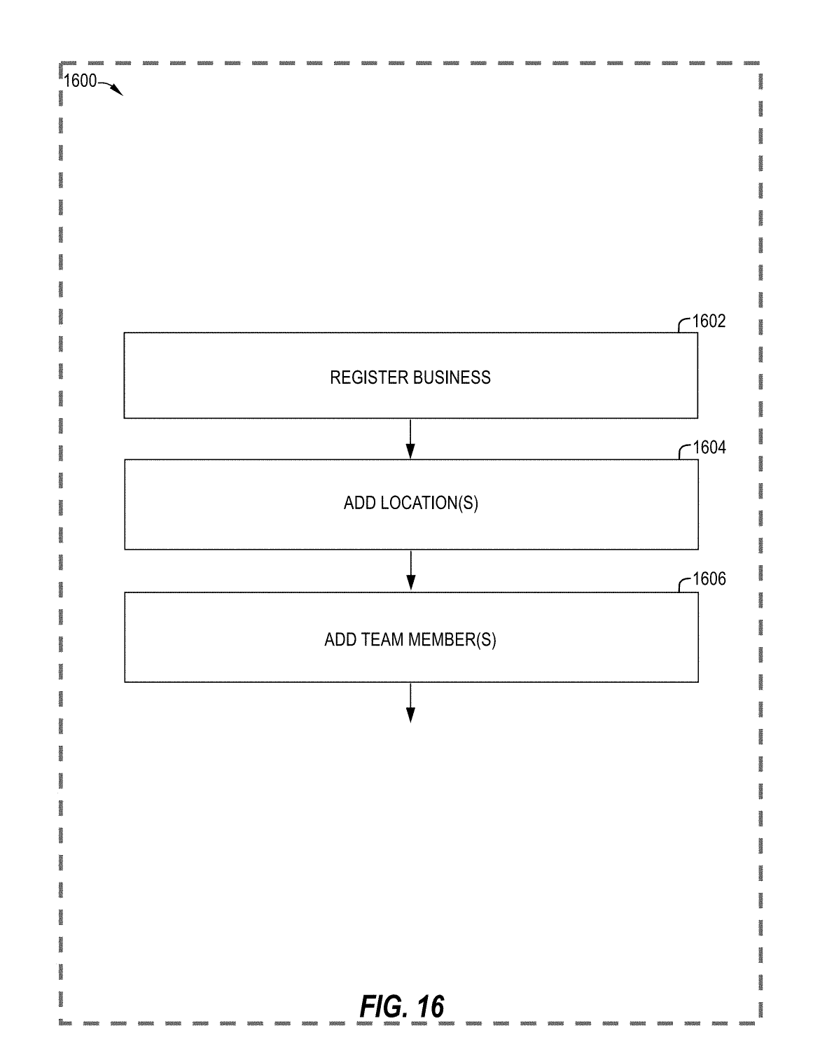

FIG. 16 is a flowchart of a method 1600 that may be performed in an automated environment, or otherwise, to configure the processing system 1500, at least in part, in accordance with at least some embodiments.

In at least some embodiments, the process or portion(s) thereof may be performed by one or more portions of the processing system 1500.

Referring now to FIG. 16, at 1602, the method may include registering a business with the processing system.

At 1604, the method may further include adding one or more locations to the processing system.

At 1606, the method may further include adding one or more team members to the processing system.

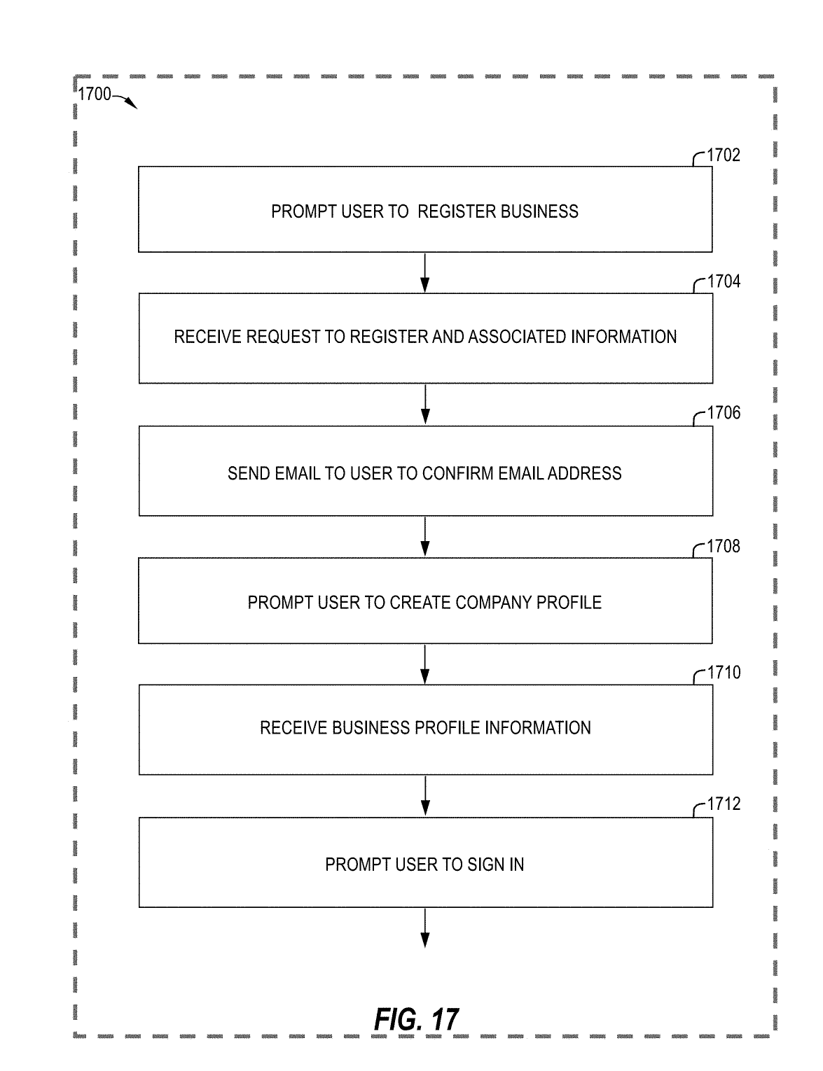

FIG. 17 is a flowchart of a method 1700 that may be performed at 1602 (“registering a business with the processing system”) in the flowchart of FIG. 16, in accordance with at least some embodiments.

As will be further described below, the process may include a plurality of prompts. The prompts may be presented in a user interface of a computing device that includes a display. A prompt in a user interface may have any form. The user interface may further include a plurality of input elements such as, for example, one or more graphical tools. A user may interact with such user interface elements (sometimes referred to hereinafter as elements (or element if singular)), by moving, clicking, pressing, actuating or otherwise activating such elements, to provide input to the processing system. Input from a user may have any form. The processing system may receive the user input and may respond, for example, by executing a series of instructions (which may be predetermined). FIGS. 1-8, discussed above, show examples of views that may be displayed by a user interface that includes prompts and/or input elements (activation of may result in the display of subsequent views with other prompt(s) and/or input element(s)).

Referring now to FIG. 17, at 1702, the method may include prompting a user to register a business with the processing system. In at least some embodiments, the user may be prompted to do so by completing a web form and submitting the web form via https.

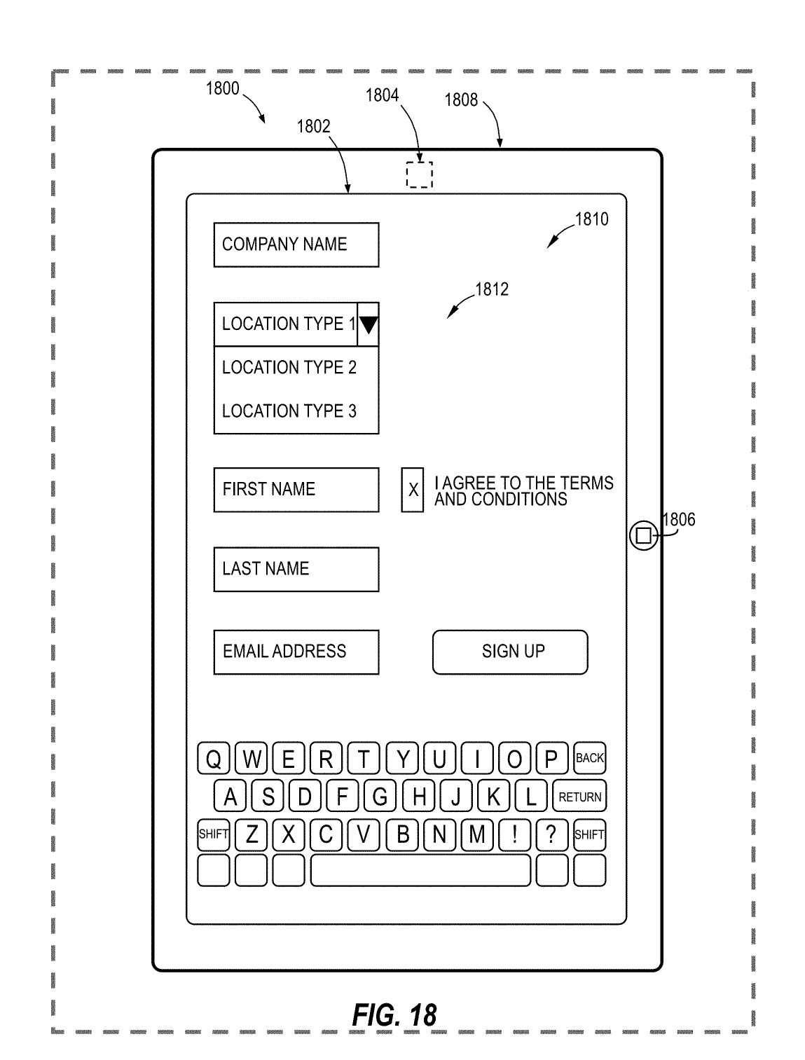

FIG. 18 shows a computing device 1800 displaying a view 1810 that may be generated and/or displayed at, or otherwise in association with, prompting the user at 1702, in accordance with at least some embodiments.

The computing device 1800 may include a display 1802, a camera 1804, a speaker (not shown), a microphone (not shown), an on/off button 1806 that can be activated to turn the computing device 1800 on and off, and a case 1808 that supports (directly and/or indirectly) each of the above, in accordance with at least some embodiments.

In the illustrated embodiment, the user is prompted to: (i) indicate the name of the business, (ii) select (e.g., by activating a pull-down menu graphical tool), a classification of the location (e.g., retail, restaurant or otherwise) operated by the business, (iii) enter the first name and last name of the user, (iv) enter an email address for the user and (v) activate a graphical tool (e.g., a button labeled “sign up”) to submit the request to register the business.

The view 1810 includes graphical tools 1812, which may be selected or otherwise activated (e.g., by a tap, entering information and/or other gesture(s) or combination(s) thereof) by a user to provide the information requested and submit the request to sign up.

Referring again to FIG. 17, at 1704, the method may further include receiving the request to register the business and the associated information from the user.

At 1706, the method may further include sending an email message to the user to verify that the email address supplied by the user is correct. The message may prompt the user to click or otherwise activate a link or other graphical tool in a view provided by the graphical user interface to confirm that the email message was received by the user and thereby confirm the accuracy of the email address.

At 1708, the method may further include prompting the user to create a business profile (in response to activation (by the user) of the graphical tool at 1706) to complete the registration process.

In at least some embodiments, this may comprise redirecting the user to a form to finalize the registration process.

The user may be prompted to use one or more graphical tools in one or more views to: (i) create a password for the account, (ii) select (e.g., using a pull down menu or other type of graphical tool) a plan (which may define a pricing tier) from a plurality of options for the account, (iii) enter billing details for the account, (iv) enter a phone number for the business, a mailing address for the business and a URL (uniform resource locator or internet address) of a website for the business, (v) upload a business logo for the account, and (vi) select a brand color (e.g., using a color selection graphical tool), which may be used for a visual border outlining each location that will be listed in a mobile application to be run on the customer device on the customer side, e.g., customer side 1506. In some embodiments, the brand color may be represented by a hexadecimal value. In some such embodiments, the user may select the brand color using, for example, a color selection graphical tool and/or by entering a hexadecimal value representing the brand color desired by the user.

At 1710, the method may further include receiving the business profile information.

At 1712, the method may further include prompting the user to sign into an administrator console (e.g., via https).

In at least some embodiments, the method may further include receiving the sign in request from the user, determining whether the sign in request satisfies sign in criteria, and if so, allowing the user access to an administrator console or other administrator service.

This may comprise generating and/or displaying any of the dashboards disclosed herein (and/or alternative dashboard(s)) if the sign in request satisfies the sign in criteria.

In at least some embodiments, an API (application programming interface) request may be generated to initiate or otherwise in association with registering a business. Table 1 shows a list of parameters or other data that may be included in the API request, i.e., account(first_name), account(last_name), account(email), account(company_name) and account(function) which in at least some embodiments may store and/or may be based at least in part on the first name, the last name, the email address, the name of the business, and the classification of the location, respectively, supplied by the user.

Table 1 further includes a list of response codes that may be generated in response to the API register request, in accordance with at least some embodiments.

TABLE 1

| Parameter | Description | Parameter Type | Data Type |
|---|---|---|---|
| account[first_name] | first_name | formData | string |
| account[last_name] | last_name | formData | string |
| account[email] | email | formData | string |
| account[company_name] | company_name | formData | string |
| account[function] | function | formData | string |

Response codes:

| HTTP Status | |
|---|---|
| Code | Reason |
| 200 | |
| 201 | Created |
| 507 | Insufficient Storage |

Some of the Tables and/or diagrams included herein include the terms: customer, team member, flare and flare range appear. In some embodiments, a customer is a user of a mobile application who is signed in as a customer type of user, a team member is a user of a mobile application who is signed in as a team member type of user and is a type of representative of the business operation at the location, a flare is a request made by a customer to a team member through a mobile application, and a flare range is a range defined by an owner or other representative of a company, wherein if a customer appeared within this range, the customer will be able to request help of a team member of the location.

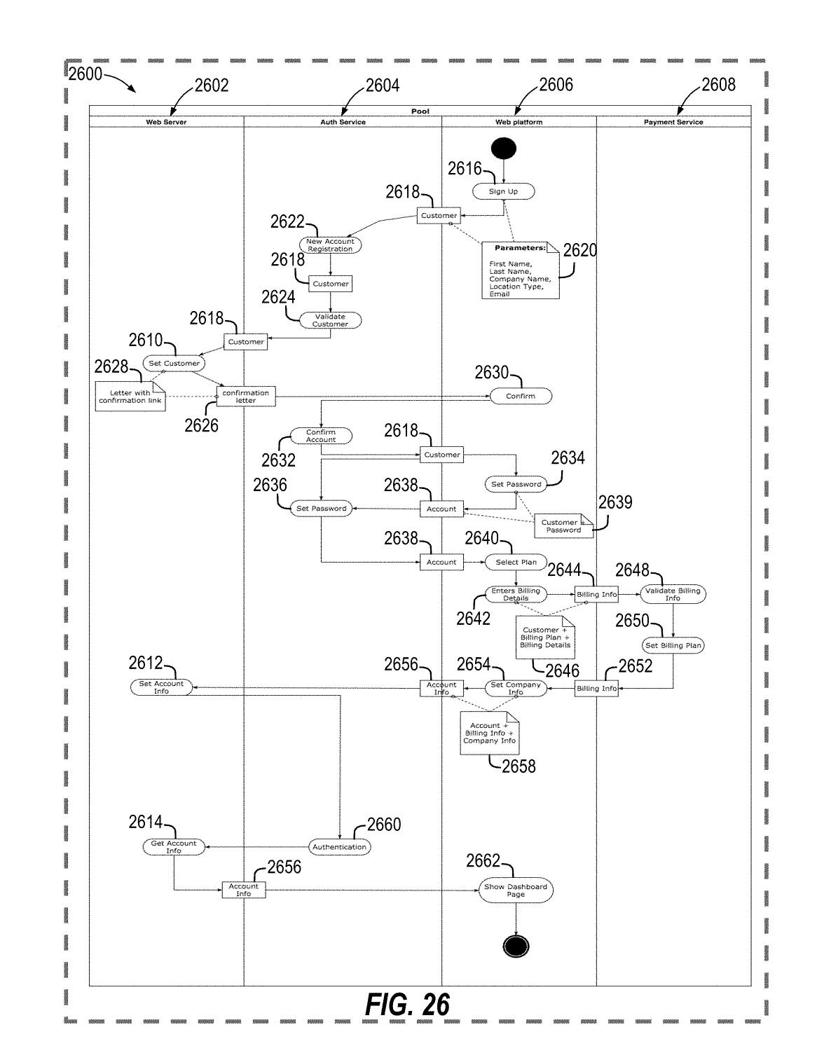

FIG. 26 is a diagram 2600 showing an architecture and a data flow that may be used in registering a business and/or at 1704-1712 in the flowchart of FIG. 17, in accordance with at least some embodiments.

Referring to FIG. 26, the architecture includes a plurality of pool resources including a web server 2602, an authorization service 2604, a web platform 2606 and a payment service 2608. As shown in the diagram 2600 and similar diagrams herein, each resource includes one or more routines, which are indicated by ovals. For example, the web platform 2610 includes a signup routine 2610, a set account info routine 2612 and a get account info routine 2614. Each routine in the diagram may be associated with a portion (of the process) that indicated by its name. For example, the set customer routine 2610 may be associated with a set customer portion of the process. The set account info routine 2612 may be associated with a set account info portion of the process. The get account info routine 2614 may be associated with a get account info portion of the process. And so on. The routines, which may have any form(s), may pass data (objects or otherwise), which are indicated by rectangles and may have any form, and may include parameters or other data components (sometimes shown within rectangles with folded corners). Flow paths of the data are indicated by directed edges. Where appropriate, data may be based at least in part on information supplied by the user. In at least some embodiments, one or more portions of the data may be global and thus may be available to a routine without being passed thereto.

Thus, the diagram 2600 indicates that the web platform 2606 may include a sign-up routine 2616 (which in view of the discussion above, may be associated with a sign-up portion of the process), which may be invoked and may pass customer data 2618, which may include data 2620 (parameters or otherwise) including first name, last name, company name, location type, and email (which may be based, at least in part, on the first name, last name, business name, location classification and email address, respectively, supplied by the user) to a new account registration routine 2622 of the authorization service 2604. The new account registration routine 2622 may pass the customer data 2618 to a validate customer routine 2624, which may be associated with a validation portion of the process and may pass the customer data to the set customer routine 2610, which may be associated with a set customer portion of the process.

The set customer routine 2610 may pass confirmation letter data 2626, which may include a letter with a confirmation link 2628, to a confirm routine 2630. The confirm routine 2630 may be associated with a confirmation portion of the process and may invoke a confirm account routine 2632, which may be associated with a confirm account portion of the process and may pass the customer data 2618 to a set password routine 2634 of the web platform 2606 and to a set password routine 2636 of the authorization service 2604. The set password routine 2634 of the web platform 2602 may be associated with a set password portion of the process and may pass account data 2638, which may include data 2639 (parameters or otherwise) including the customer data 2618, and password data, to the set password routine 2636, which may also be associated with a set password portion of the process and may pass the account data 2638 to a select plan routine 2640, which may be associated with a select plan portion of the process.

The select plan routine 2640 may invoke an enters billing details routine 2642, which may be associated with an enters billing details portion of the process and may pass billing info data 2644, which may include data 2646 including the customer data 2618, billing plan and billing details, to a validate billing info routine 2648, which may be associated with a validate billing info portion of the process and may invoke a set billing plan routine 2650. The set billing plan routine 2650 may be associated with a set billing plan portion of the process and may pass billing info data 2652 to a set company info routine 2654, which may be associated with a set company info portion of the process and may pass account info data 2656, which may include data 2658 (parameters or otherwise) including the account data 2638, the billing info data 2652 and company info data, to the set account info routine 2612. The set account info routine 2612 may invoke an authentication routine 2660, which may be associated with an authentication portion of the process and may invoke the get account info routine 2614, which may pass the account info data 2656 to a show dashboard page routine 2664, which may be associated with a show dashboard page portion of the process.

In at least some embodiments, billing information is transmitted to an on-line payment system, for example STRIPE, and a subscription is set up. Sensitive credit card data is not stored on the platform. The authorization service 2604 may be configured to resolve authentication of users. Passwords may be stored as a hashed string using an adaptive hashing function, for example Bcrypt.

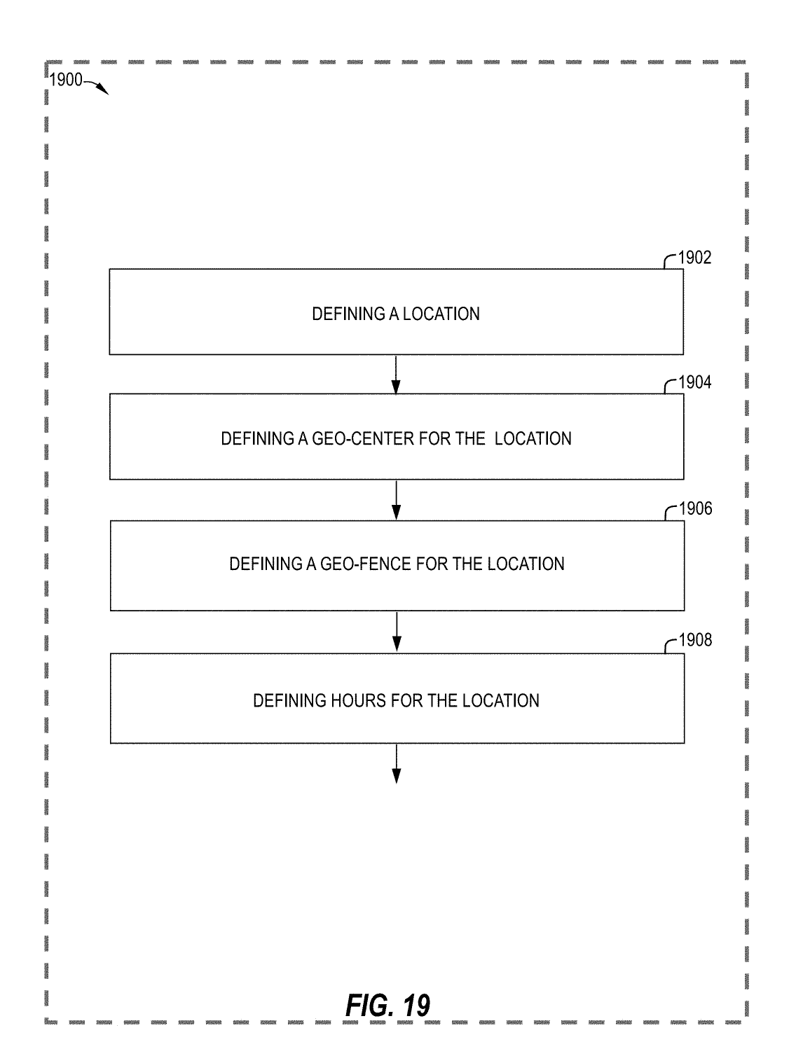

FIG. 19 is a flowchart of a method 1900 that may be performed at 1604 (“adding one or more locations to the processing system”) in the flowchart of FIG. 16, in accordance with at least some embodiments.

Referring to FIG. 19, at 1902, the method may include defining a location.

At 1904, the method may further include defining a geo-center for the location.

At 1906, the method may further include defining a geo-fence for the location.

At 1908, the method may further include defining hours for the location.

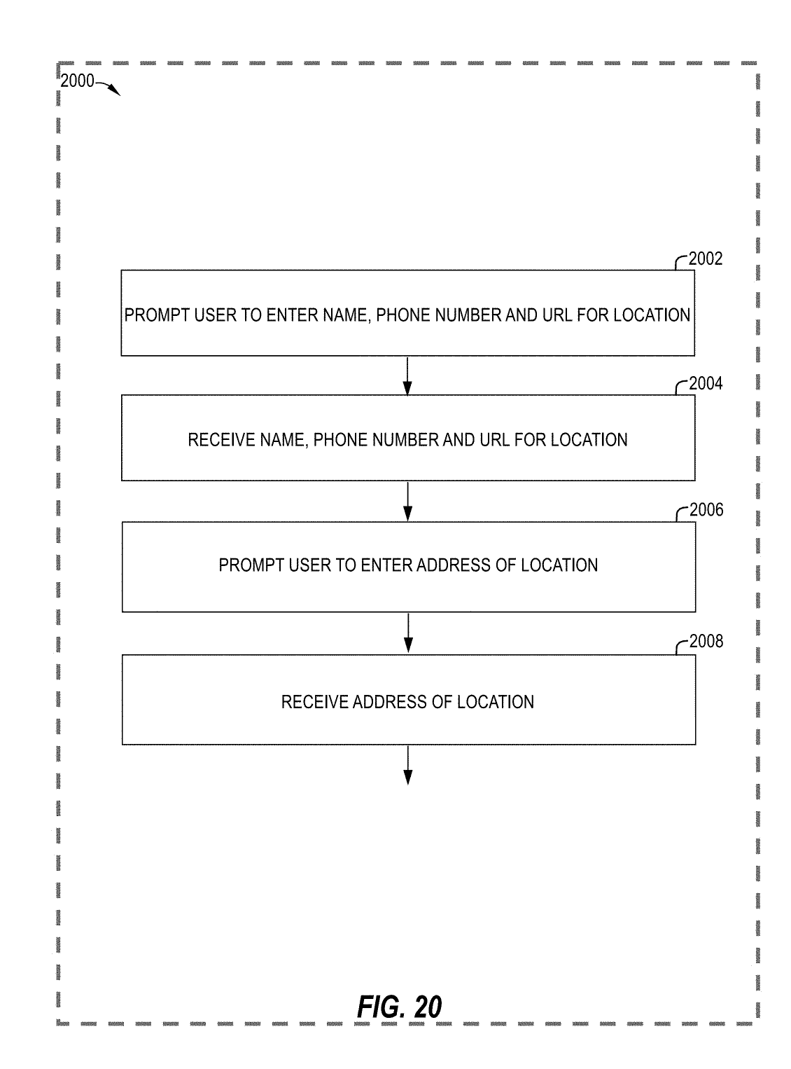

FIG. 20 is a flowchart of a method 2000 that may be performed at 1902 (“defining a location”) in the flowchart of FIG. 19, in accordance with at least some embodiments.

Referring to FIG. 20, at 2002, the method may include prompting a user to enter a name for the location, a unique phone number for the location, and a URL of a website for the location.

At 2004, the method may further include receiving the name, unique phone number and the URL for the location.

At 2006, the method may further include prompting the user to enter an address of the location.

At 2008, the method may further include receiving the address of the location. In at least some embodiments, the address may be received character by character while the address is being entered by the user, and the method may include generating a list of suggestions (e.g., complete addresses) based at least in part on characters as they are received. The list of suggestions may thus be revised after each character is received. The user may continue to enter the address until it is complete, or alternatively, the user may select an address from the list of suggestions displayed at any given point in time.

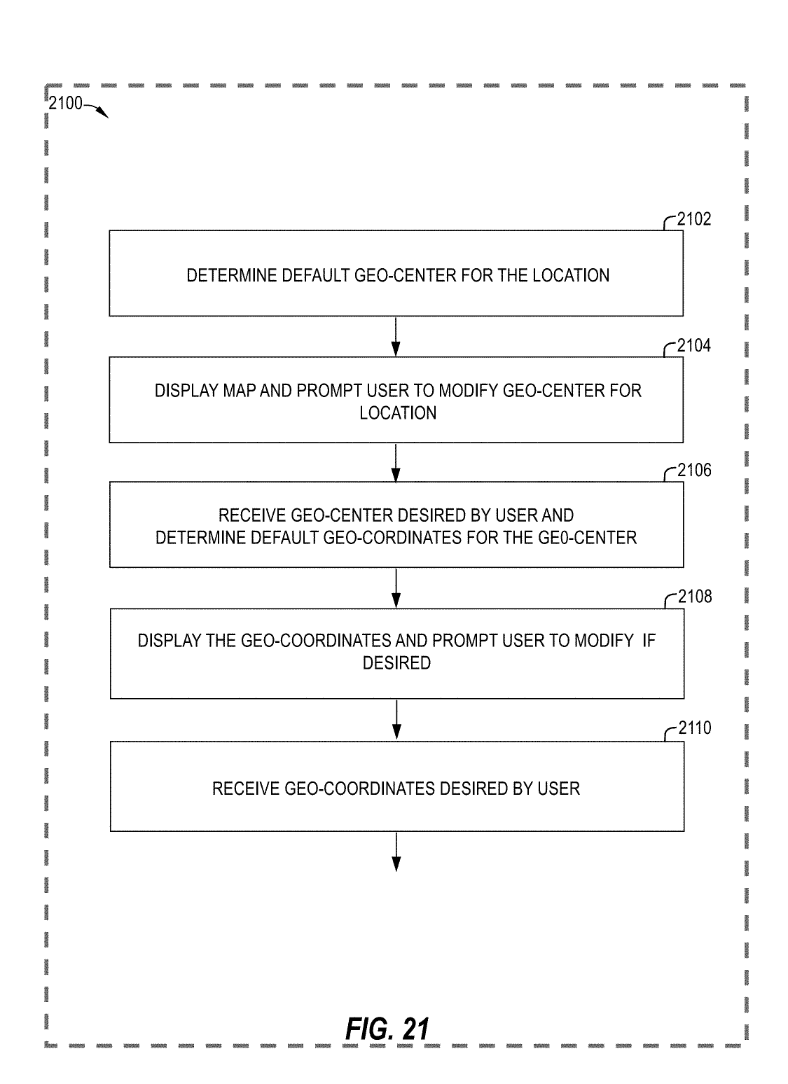

FIG. 21 is a flowchart of a method 2100 that may be performed at 1904 (“defining a geo-center of a location”) in the flowchart of FIG. 19, in accordance with at least some embodiments.

Referring to FIG. 21, at 2102, the method may include determining a default geo-center for the location.

At 2104, the method may further include generating and/or displaying a view having a map that includes the location and default geo-center and prompting the user to modify the geo-center if the user so desires.

In at least some embodiments, the view may include a push pin or other graphical tool representing the default geo-center, and prompt the user to drag or otherwise activate the push pin or other graphic tool to move the geo-center from the default geo-center to a new geo-center for the location if the user so desires.

At 2106, the method may further include receiving information indicative of the geo-center (default or modified) desired by the user for the location, and determining geo-coordinates, based at least in part thereon, for the geo-center of the location.

At 2108, the method may further include generating and/or displaying a view having a map that includes the location and the geo-coordinates and prompt the user to modify the geo-coordinates if the user so desires.

In at least some embodiments, the view may show the geo-coordinates in a field (e.g., text field editable by the user) or in association with some other graphical tool(s) activatable by the user, and may prompt the user to use the graphical tool(s) to modify the geo-coordinates if the user so desires.

At 2110, the method may further include receiving information indicative of the geo-coordinates (default or modified) desired by the user.

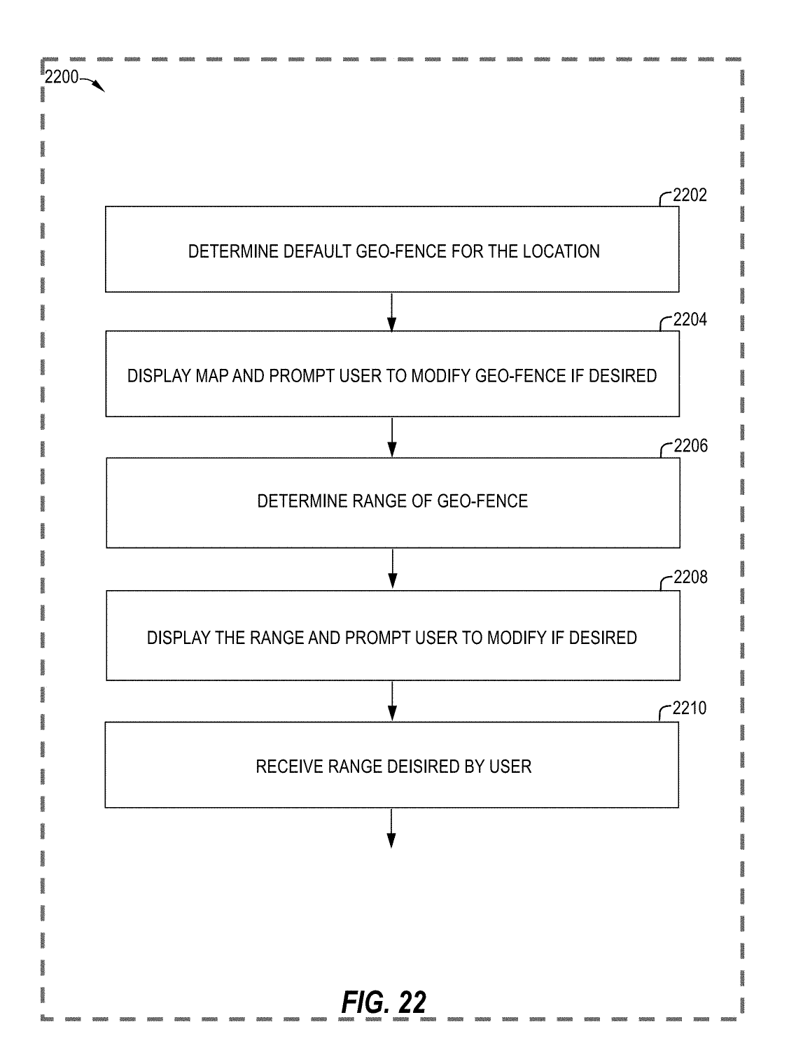

FIG. 22 is a flowchart of a method 2200 that may be performed at 1906 (“defining a geo-fence for the location”) in the flowchart of FIG. 19, in accordance with at least some embodiments.

Referring to FIG. 22, at 2202, the method may include determining a default geo-fence for the location.

At 2204, the method may further include generating and/or displaying a view having a map that includes an outline or other indication representing the geo-fence, and prompting the user to modify the range of the geo-fence if the user so desires.

In at least some embodiments, the view may prompt the user to modify the range of geo-fence, if the user so desires, by dragging the outline or other indication (and/or to activate one or more other graphical tool(s)) to modify the size and/or shape of the outline or other indication representing the geo-fence.

At 2206, the method may further include receiving information indicative of the geo-fence (default or modified) desired by the user for the location, and/or determining the range thereof, based at least in part thereon.

At 2208, the method may further include generating and/or displaying a view that includes an indication of the range and prompting the user to modify the range if the user so desired.

In at least some embodiments, the view may show a value of the range (e.g., expressed in feet or meters) in a field (e.g., text field editable by the user) and prompt the user to modify the value to indicate a modified range if the user so desires.

At 2210 the method may further include receiving information indicative of the range (default or modified) desired by the user.

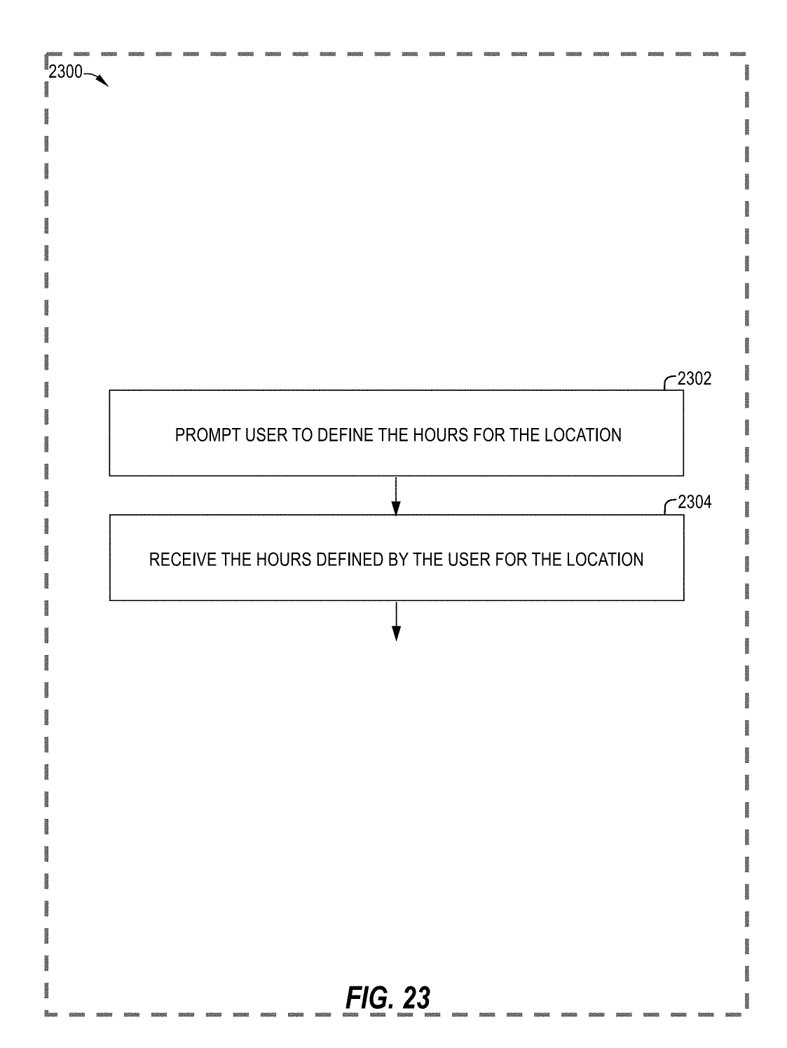

FIG. 23 is a flowchart of a method 2300 that may be performed at 1908 (“defining hours for the location”) in the flowchart of FIG. 19, in accordance with at least some embodiments.

Referring to FIG. 23, at 2302, the method may include prompting a user to define the hours of operation for the location.

This may include generating and/or displaying one or more views that show the days of the week and graphical tools activatable by the user to define the hours (e.g., the business operations hours of operation at the location) for each day.

In at least some embodiments, the graphical tools may include a seven set of tools each associated with a respective day of the week. Each set may include a graphical tool activatable by the user to indicate that the location is open 24 hours on the respective day, a graphical tool activatable by a user to indicate that the location is closed 24 hours on the respective day, and one or more sliders or other graphical tools activatable by the user to indicate hours (e.g., the business operation's hours of operation at the location) if the location is open on the respective day but not for all 24 hours of the respective day.

At 2304, the method may further include receiving the hours, defined by the user, for the location.

In at least some embodiments, a company owner (sometimes referred to herein as a user) or other representative (sometimes referred to herein as a user) of the company adds the location to the company account. In at least some embodiments, a company may be a store or a restaurant. To add the location, the company owner or other representative may enter the following information into an electronic form: location name, address, phone number, URL to location page on the company's website, location working hours for the week, GPS coordinates and Flare range.

In at least some embodiments, GPS coordinates may be determined using a GOGGLE PLACE API according to a location address entered by company owner or other representative. The company owner or other representative may enter an address and then adjust the GPS coordinates to make it more precise. In at least some embodiments, the flare range may be adjusted from 100 ft up to 1000 ft. Also, the company owner or other representative may have an opportunity to prepare a csv file, based on a template provided on the platform, for adding multiple (e.g., many) locations to his company account.

In at least some embodiments, an API request may be generated to initiate or otherwise in association with adding a location. Table 2 shows a list of parameters or other data that may be included in the API request, i.e., authorization, location, address, phone, uri, longitude, latitude, flare_range, schedules(day_of week), schedules(open_from), schedules(open_until), schedules(open_24_hours), schedules(closed), which in at least some embodiments may store and/or may be based at least in part on the information supplied by the user.

Table 2 further includes a list of response codes that may be generated in response to the API register request, in accordance with at least some embodiments.

TABLE 2

| Parameter | Description | Parameter Type | Data Type |
|---|---|---|---|
| Authorization | Authentication token | header | string |
| location | location_name | query | string |
| address | location address | query | string |
| phone | location phone | query | string |
| url | location url | query | string |
| longitude | coordinates location | query | float |
| latitude | coordinates location | query | float |
| flare_range | Flare_range in ft | query | long |
| schedules[day_of_week] | Sun, Mon, Tue, Wed, Thu, Fri, Sat | formData | string |
| schedules[open_from] | 09:00 AM | formData | string |
| schedules[open_until] | 06:00 PM | formData | string |
| schedules[open_24_hours] | open 24 hours-yes-true | formData | boolean |
| schedules[closed] | closed all day-true | formData | boolean |

Response codes:

| HTTP Status Code | Reason |
|---|---|
| 200 | Ok |
| 400 | Bad Request |
| 401 | Unauthorized |
| 403 | Forbidden |

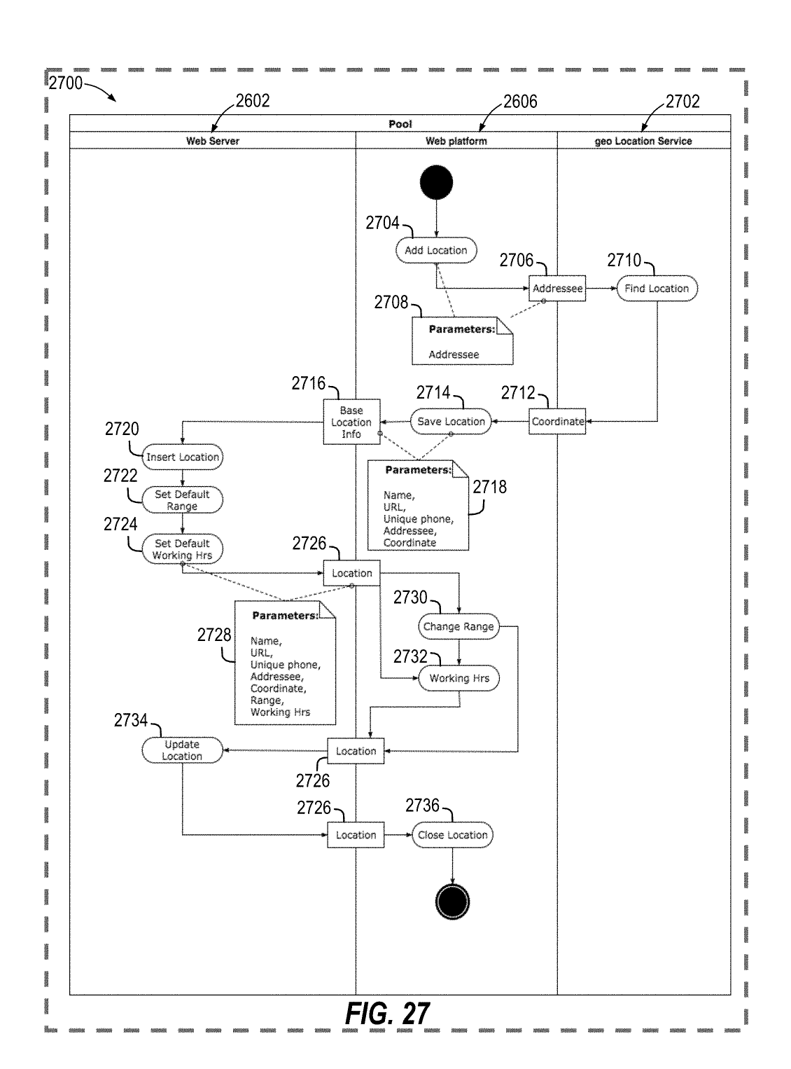

FIG. 27 is a diagram 2700 showing an architecture and a data flow that may be used in adding a location and/or at 2002-2008, 2102-2110, 2202-2210 and 2302-2304 in the flowcharts of FIG. 20, FIG. 21, FIG. 22 and FIG. 23, respectively, in accordance with at least some embodiments.

Referring to FIG. 27, the architecture includes a plurality of pool resources including the web server 2602, the web platform 2606 and a geo location service 2702. The web platform 2606 may include an add location routine 2704, which may be associated with an add location portion of the process. The add location routine 2704 may be invoked and may pass addressee data 2706, which may include data 2708 (parameter or otherwise), addressee, to a find location routine 2710 of the geo location service 2702. The find location routine 2710 may be associated with a find location portion of the process and may pass coordinate data 2712 to a save location routine 2714, which may be associated with a save location portion of the process and may pass base location info data 2716, which may include data 2718 (parameters or otherwise) name, URL, unique phone, addressee, coordinate, to an insert location routine 2720, which may be associated with an insert location portion of the process.

The insert location routine 2720 may invoke a set default range routine 2722, which may be associated with a set default range portion of the process and may invoke a set default working hours routine 2724, which may be associated with a set default working hours portion of the process. The set default working hours routine 2724 may pass location data 2726, which may include data 2728 (parameters or otherwise) name, URL, unique phone, addressee, coordinate, range, working hours, to a change range routine 2730 and a working hours routine 2732, which may be associated with a change range portion of the process and a working hours portion of the process, respectively, which may pass the location data 2726 to an update location routine 2734, which may be associated with an update location portion of the process and may pass the location data 2726 to a close location routine 2736, which may be associated with a close location portion of the process.

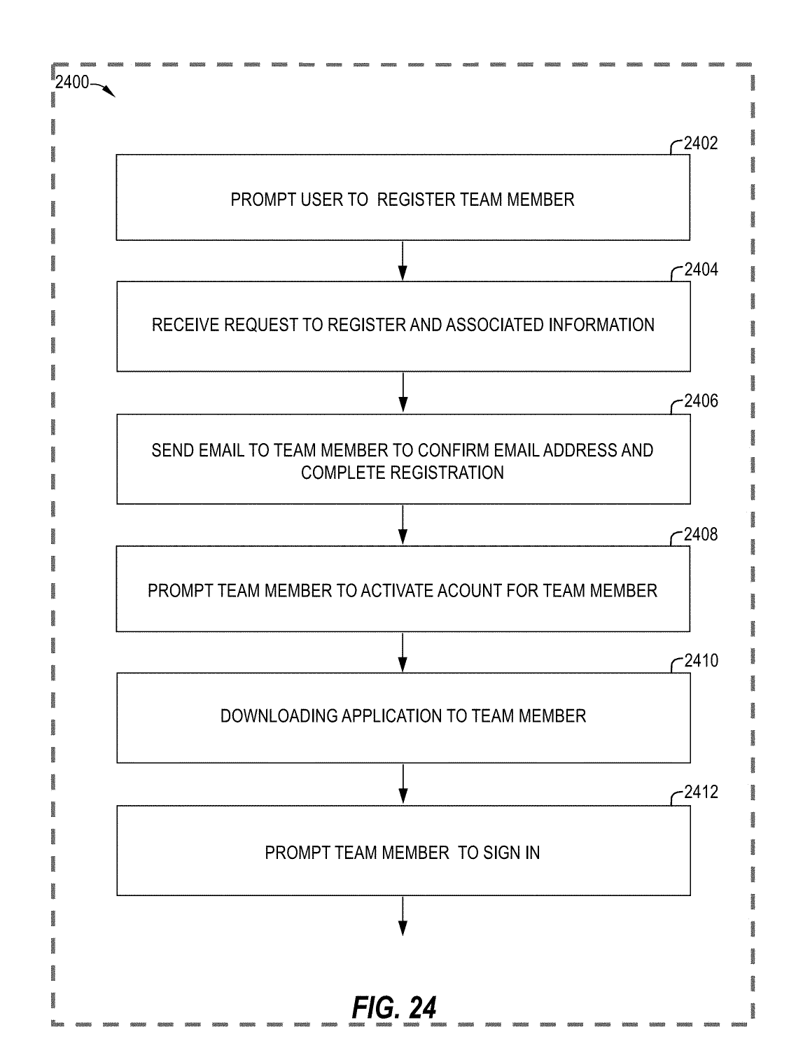

FIG. 24 is a flowchart of a method 2400 that may be performed at 1602 (“adding a team member”) in the flowchart of FIG. 16, in accordance with at least some embodiments.

Referring now to FIG. 24, at 2402, the method may include prompting a user to register a team member with the processing system. In at least some embodiments, the user may be prompted to do so by completing a web form and submitting the web form via https.

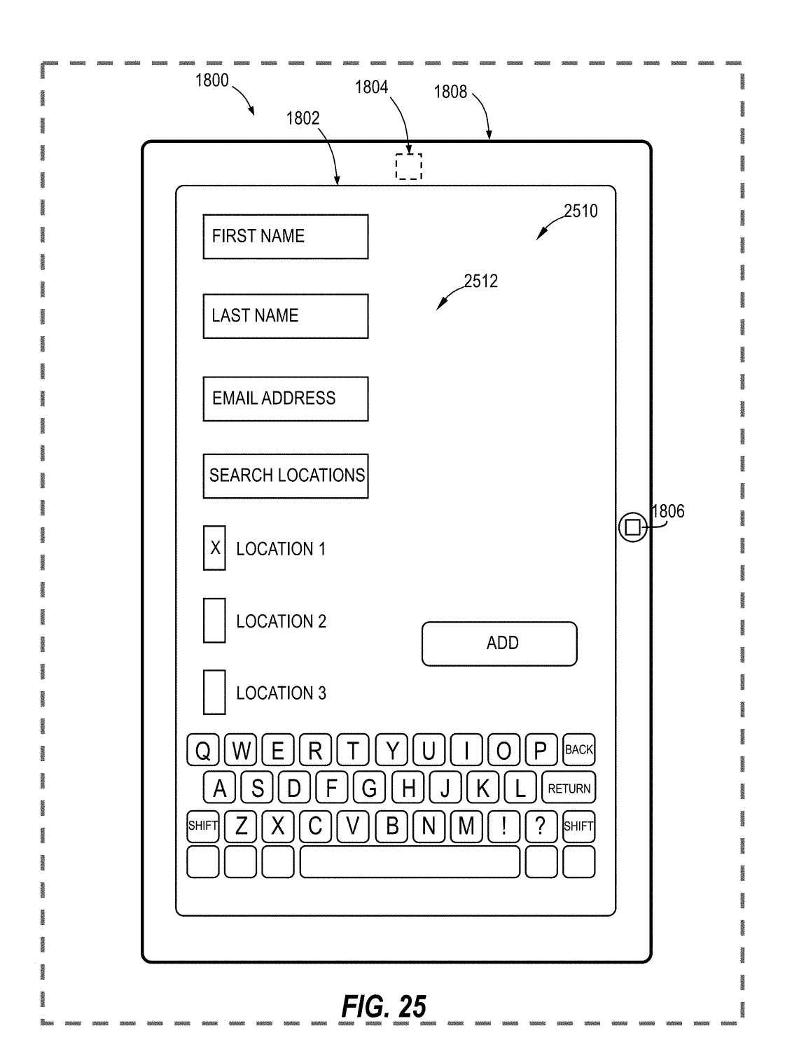

FIG. 25 shows the computing device 1800 that may be employed by a user, in accordance with at least some embodiments.

The display 1802 is shown displaying a view 2510 that may be generated and/or displayed at, or otherwise in association with, prompting the user at 2402.

In the illustrated embodiment, the user is prompted to: (i) indicate the name of the team member, (ii) enter an email address for the team member, (iii) select or otherwise indicate a location for the team member and (v) submit the request to register the team member.

The view includes graphical tools 2512, which may be selected or otherwise activated (e.g., by a tap, entering information and/or other gesture(s) or combination(s) thereof) by a user to provide the information requested and submit the request to register the team member.

In at least some embodiments, the view may include a graphical tool activatable by the user to request a list of locations that have been added for the business, and one or more graphical tools activatable by the user to select one or more of such locations for the business.

Referring again to FIG. 24, at 2404, the method may further include receiving the request to register the team member and the associated information.

At 2406, the method may further include sending an email message to the team member to verify that the email address supplied by the user is correct. The message may prompt the team member to click or otherwise activate a button or other graphical tool in a view provided by the graphical user interface to confirm that the email message was received by the team member (to confirm the accuracy of the email address) and complete the registration of the team member.

At 2408, the method may further include prompting the team member to activate an account for the team member. This may include prompting the team member to use one or more graphical tools in one or more views to: (i) create a password for the account and (ii) download and install an application (sometimes referred to herein as a “mobile application”) on a mobile device of the team member.

At 2410, the method may further include downloading the application to the computing device of the team member.

At 2412, the method may further include prompting the team member to sign in via the mobile application on the mobile device of the team member.

In at least some embodiments, the method may further include receiving a sign in request from the team member, determining whether the sign in request satisfies sign in criteria and allowing the team member access if the sign in request satisfies the sign in criteria.

In at least some embodiments, a company owner or other representative can add a Team Member to the company account. In at least some embodiments, the company owner or other representative enters the following information into an electronic form: team member's first name, last name, email and assign him to a certain location(s). In at least some embodiments, the company owner or other representative can also add multiple (e.g., many) team members based on a csv template, which in at least some embodiments, may be downloaded from the form.

In at least some embodiments, an API request may be generated to initiate or otherwise in association with adding a team member. Table 3 shows a list of parameters or other data that may be included in the API request, i.e., authorization, email, first_name, last_name and location_ids, which in at least some embodiments may store and/or may be based at least in part on the information supplied by the user.

Table 3 further includes a list of response codes that may be generated in response to the API register request, in accordance with at least some embodiments.

TABLE 3

| Parameter | Description | Parameter Type | Data Type |
|---|---|---|---|
| Authorization | Authentication token | header | string |
| email | team member email | query | string |
| first_name | team member first_name | query | string |
| last_name | team member last_name | query | string |
| location_ids | array of location id | query | long |

Response codes:

| HTTP Status Code | Reason |
|---|---|
| 200 | Ok |
| 400 | Bad Request |
| 401 | Unauthorized |
| 403 | Forbidden |

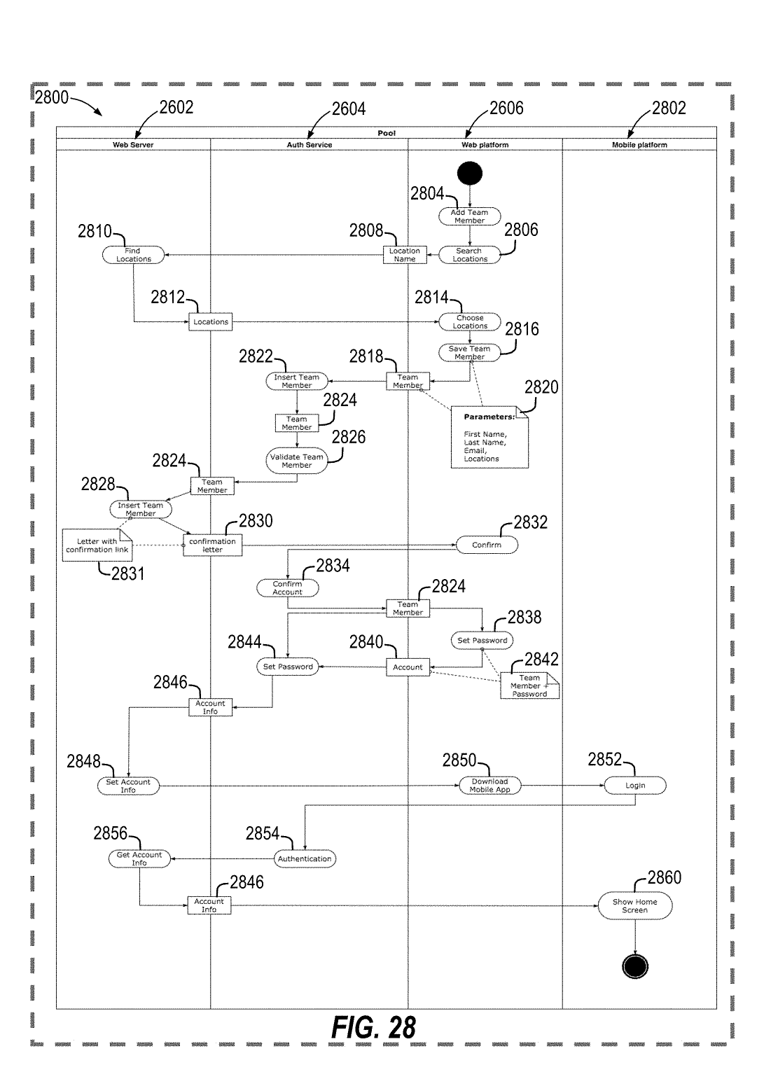

FIG. 28 is a diagram 2800 showing an architecture and a data flow that may be used in association with adding a team member and/or at 2402-2412 in the flowchart of FIG. 24, in accordance with at least some embodiments.

Referring to FIG. 28, the architecture includes a plurality of pool resources including the web server 2602, the authorization service 2604, the web platform 2606 and a geo location service 2802.

An add team member routine 2804, which may be associated with an add member portion of the process, may be invoked and may invoke a search locations routine 2806, which may be associated with a search locations portion of the process and may pass location name data 2808 to a find locations routine 2810.

The find locations routine 2810 may be associated with a find locations portion of the process and may pass locations data 2812 to a choose locations routine 2814, which may be associated with a choose locations portion of the process and may invoke a save team member routine 2816, which may be associated with a save team member portion of the process and may pass team member data 2818, which may include data 2820 (parameters or otherwise) first name, last name, email and locations (which may be based at least in part on the first name, last name, email and location(s) supplied by the user) to an insert team member routine 2822, which may be associated with an insert team member portion of the process.

The insert team member routine 2822 may pass team member data 2824 to a validate team member routine 2826, which may be associated with a validate team member portion of the process and may pass the team member data 2824 to an insert team member routine 2828, which may be associated with an insert team member portion of the process and may pass confirmation letter data 2830, which may include data 2831 (parameter or otherwise), letter with confirmation link, to a confirm routine 2832, which may be associated with a confirm portion of the process and may invoke a confirm account routine 2834, which may pass the team member data 2824 to a set password routine 2838, which may be associated with a set password portion of the process and may pass account data 2840, which may include data 2842 (parameters or otherwise), team, member and password, to a set password routine 2844, which may be associated with a set password portion of the process.

The set password routine 2844 may pass account info data 2846 to a set account info routine 2848, which may be associated with a set account info portion of the process and may invoke a download mobile application routine 2850, which may be associated with a download mobile application portion of the process and may invoke a login routine 2852, which may be associated with a login portion of the process and may invoke an authentication routine 2854, which may be associated with an authenticate portion of the process and may invoke a get account info routine 2856, which may be associated with a get account info portion of the process and may pass the account info data 2846 to a show home screen routine 2860, which may be associated with a show home screen portion of the process.

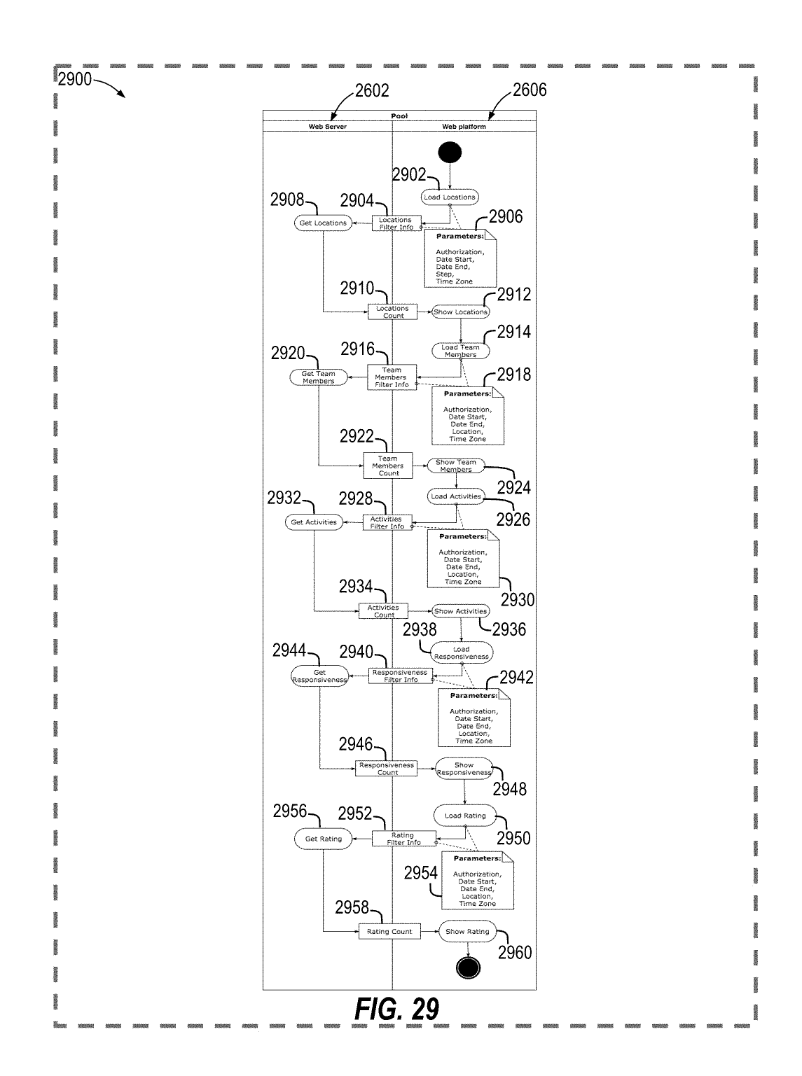

FIG. 29 is a diagram 2900 showing an architecture and a data flow that may be used in providing an administrator dashboard and/or at 1712 in the flowchart of FIG. 17, in accordance with at least some embodiments.

Referring to FIG. 29, the architecture includes a plurality of pool resources including the web server 2602 and the web platform 2606.

The web platform 2606 includes a load locations routine 2902, which may be associated with a load locations portion of the process. The load locations routine 2902 may be invoked and may pass location filter info data 2904, which may include data 2906 (parameters or otherwise), authorization, date start, date end, step and time zone, to a get locations routine 2908, which may be associated with a get locations portion of the process and may pass locations count data 2910 to a show locations routine 2912, which may be associated with a show locations portion of the process and may invoke a load team members routine 2914, which may be associated with a load team members portion of the process and may pass team members filter info data 2916, which may include data 2918 (parameters or otherwise), authorization, date start, date end, location and time zone, to a get team members routine 2920, which may be associated with a get team members portion of the process.

The get team members routine 2920 may pass team members count data 2922 to a show team members routine 2924, which may be associated with a show team members portion of the process, which may invoke a load activities routine 2926, which may be associated with a load activities portion of the process and may pass activities filter info data 2928, which may include data 2830 (parameter or otherwise), authorization, date start, date end, location and time zone, to a get activities routine 2932, which may be associated with a get activities portion of the process and may pass activities count data 2934 to a show activities routine 2936, which may be associated with a show activities portion of the process and which may invoke a load responsiveness routine 2938, which may be associated with a load responsiveness portion of the process and may pass responsiveness filter info data 2940, which may include data 2942 (parameters or otherwise), authorization, date start, date end, location and time zone, to a get responsiveness routine 2944, which may be associated with a get responsiveness portion of the process.

The get responsiveness routine 2944 may pass responsiveness count data 2946 to a show responsiveness routine 2948, which may be associated with a show responsiveness portion of the process, which may invoke a load rating routine 2950, which may be associated with a load rating portion of the process and may pass rating filter info data 2952, which may include data 2954 (parameters or otherwise), authorization, date start, date end, location and time zone, to a get rating routine 2956, which may be associated with a get rating portion of the process and may pass rating count data 2958 to a show rating routine 2960, which may be associated with a show rating portion of the process.

In at least some embodiments, a company owner or other representative can enter an overview, and will be shown a map with all of the locations under the company, statistics includes amount of location, amount of team members, amount of activities, value of responsiveness, average rating of company's locations for the period (which in at least some embodiments, can be set with date picker). Also, in at least some embodiments, short listed locations will be shown with brief statistics.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein.

Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments may be implemented in any of numerous ways. One or more aspects and embodiments of the present application involving the performance of processes or methods may utilize program instructions executable by a device (e.g., a computer, a processor, or other device) to perform, or control performance of, the processes or methods.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in field programmable gate arrays (FPGAs) or other semiconductor devices, or other tangible computer storage medium) encoded with one or more programs that, when executed on one or more computers or other processors, perform methods that implement one or more of the various embodiments described above.

The computer readable medium or media may be transportable, such that the program or programs stored thereon may be loaded onto one or more different computers or other processors to implement various ones of the aspects described above. In some embodiments, computer readable media may be non-transitory media.

Additionally, it should be appreciated that according to one aspect, one or more computer programs that when executed perform methods of the present application need not reside on a single computer or processor, but may be distributed in a modular fashion among a number of different computers or processors to implement various aspects of the present application.

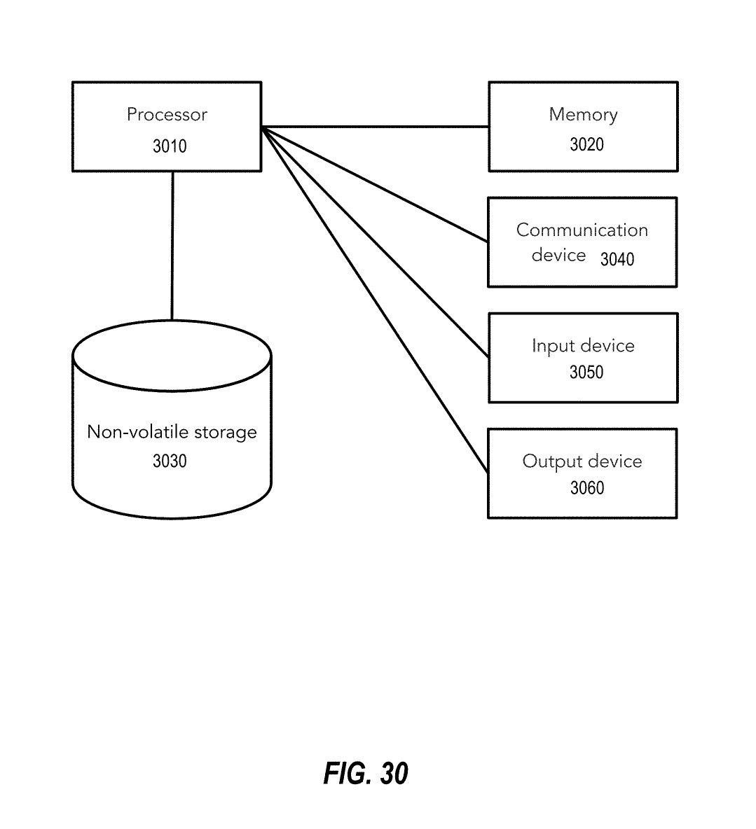

FIG. 30 is a block diagram of a computer architecture 3000 according to some embodiments. In some embodiments, one or more of the systems (or portion(s) thereof), apparatus (or portion(s) thereof) and/or devices (or portion(s) thereof) disclosed herein may have an architecture that is the same as and/or similar to one or more portions of the architecture 3000.

In some embodiments, one or more of the methods (or portion(s) thereof) disclosed herein may be performed by a system, apparatus and/or device having an architecture that is the same as or similar to the architecture 3000 (or portion(s) thereof). The architecture may be implemented as a distributed architecture or a non-distributed architecture.

Referring to FIG. 30, in accordance with at least some embodiments, the architecture 3000 may include one or more processors 3010 and one or more articles of manufacture that comprise non-transitory computer-readable storage media (e.g., memory 3020 and one or more non-volatile storage media 3030). The processor 3010 may control writing data to and reading data from the memory 3020 and the non-volatile storage device 3030 in any suitable manner, as the aspects of the disclosure provided herein are not limited in this respect. The storage media may store one or more programs and/or other information for operation of the architecture 3000. In at least some embodiments, the one or more programs include one or more instructions to be executed by the processor 3010 to provide one or more portions of one or more tasks and/or one or more portions of one or more methods disclosed herein. In some embodiments, other information includes data for one or more portions of one or more tasks and/or one or more portions of one or more methods disclosed herein. To perform any of the functionality described herein, the processor 3010 may execute one or more processor-executable instructions stored in one or more non-transitory computer-readable storage media (e.g., the memory 3020), which may serve as non-transitory computer-readable storage media storing processor-executable instructions for execution by the processor 3010.

The terms “program” or “software” are used herein in a generic sense to refer to any type of computer code or set of computer-executable instructions that may be employed to program a computer or other processor to implement various aspects as described above. Additionally, it should be appreciated that according to one aspect, one or more computer programs that when executed perform methods of the present application need not reside on a single computer or processor, but may be distributed in a modular fashion among a number of different computers or processors to implement various aspects of the present application.

Computer-executable instructions may be in many forms, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smart phone or any other suitable portable or fixed electronic device.

In at least some embodiments, the architecture 3000 may have one or more communication devices 3040, which may be used to interconnect the architecture to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, in at least some embodiments, the architecture 3000 may have one or more input devices 3050 and/or one or more output devices 3060. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, the architecture 3000 may receive input information through speech recognition or in other audible formats.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

It should be understood that the features disclosed herein can be used in any combination or configuration. Thus, in at least some embodiments, any one or more of the embodiments (or feature(s) thereof) disclosed herein may be used in association with any other embodiment(s) (or feature(s) thereof) disclosed herein. Similarly, in at least some embodiments, any one or more of the features disclosed herein may be used without any one or more other feature disclosed herein.

Unless stated otherwise, a computing device is any type of device that includes at least one processor.

Unless stated otherwise, a processing device is any type of device that includes at least one processor.

Unless stated otherwise, a processing system is any type of system that includes at least one processor.

Unless stated otherwise, a mobile (or portable) computing device includes, but is not limited to, any computing device that may be carried in one or two hands, worn on a body (or portion(s) thereof), affixed to a body (or portion(s) thereof) and/or implanted in a body (or portion(s) thereof).

Unless stated otherwise, a processor may comprise any type of processor. For example, a processor may be programmable or non-programmable, general purpose or special purpose, dedicated or non-dedicated, distributed or non-distributed, shared or not shared, and/or any combination thereof. A processor may include, but is not limited to, hardware, software (e.g., low-level language code, high-level language code, microcode), firmware, and/or any combination thereof.

Unless stated otherwise, a program may include, but is not limited to, instructions in a high-level language, low-level language, machine language and/or other type of language or combination thereof.

Unless stated otherwise, a “communication link” may comprise any type(s) of communication link(s), for example, but not limited to, wired links (e.g., conductors, fiber optic cables) or wireless links (e.g., acoustic links, radio links, microwave links, satellite links, infrared links or other electromagnetic links) or any combination thereof, each of which may be public and/or private, dedicated and/or shared. In some embodiments, a communication link may employ a protocol or combination of protocols including, for example, but not limited to the Internet Protocol.

Unless stated otherwise, information may include data and/or any other type of information. Also, unless stated otherwise, data or other information may have any form(s) and may be received from any source(s) (internal and/or external).

Unless stated otherwise, a signal (control or otherwise) may have any form, for example, analog and/or digital, and is not limited to a single signal on a single line but rather, for example, may comprise multiple signals on a single line or multiple signals on multiple lines. Also, unless stated otherwise, a signal (control or otherwise) may have any source(s), internal and/or external.

Unless stated otherwise, terms such as, for example, “in response to” and “based on” mean “in response (directly and/or indirectly) at least to” and “based (directly and/or indirectly) at least on”, respectively, so as not to preclude intermediates and being responsive to and/or based on, more than one thing.

Unless stated otherwise, the term “represents” means “directly represents” and/or “indirectly represents.”

Unless stated otherwise, terms such as, for example, “comprises,” “has,” “includes,” and all forms thereof, are considered open-ended, so as not to preclude additional elements and/or features.

Also, unless stated otherwise, terms such as, for example, “a,” “one,” “first,” are considered open-ended, and do not mean “only a”, “only one” or “only a first”, respectively.

Also, unless stated otherwise, the term “first” does not, by itself, require that there also be a “second.”

Also, unless stated otherwise, the phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Elements other than those specifically identified by the “and/or” clause may optionally be present, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

The present invention should therefore not be considered limited to the particular embodiments described above. Various modifications, equivalent processes, as well as numerous structures to which the present invention may be applicable, will be readily apparent to those skilled in the art to which the present invention is directed upon review of the present disclosure.

What is claimed is:

1. A method, comprising:
receiving, by a processing system, a message from a computing device, the message including a request for assistance and/or to provide a review relating to a business operation at a location;
determining, by the processing system, if access criteria of a customer assistance and/or customer review service associated with the business operation at the location is satisfied, wherein the access criteria of the customer assistance and/or customer review service comprises spatial criteria related to the location of the business operation, and wherein said determining if the access criteria of the customer assistance and/or customer review service is satisfied comprises determining if a location of the computing device satisfies the spatial criteria related to the location of the business operation; and
allowing, by the processing system, the computing device to access the customer assistance and/or customer review service if it is determined that the access criteria of the customer assistance and/or customer review service is satisfied.

2. The method of claim 1, wherein said business operation has business hours at the location of the business operation;
wherein the access criteria of the customer assistance and/or customer review service further comprises temporal criteria related to the business hours of the business operation at the location of the business operation; and
wherein said determining if the access criteria of the customer assistance and/or customer review service is satisfied comprises determining if the location of the computing device satisfies the spatial criteria related to the location of the business operation and determining if the temporal criteria related to the business hours of the business operation is satisfied.

3. The method of claim 2, wherein said determining if the temporal criteria related to the business hours of the business operation is satisfied comprises determining if a time of day at which the message is received satisfies the temporal criteria related to the business hours of the business operation.

4. The method of claim 1, wherein said request included in said message from the computing device comprises a request from a user of the computing device for customer assistance from an associate of the business operation.

5. The method of claim 1, wherein said request included in said message from the computing device comprises a request from a user of the computing device to provide a review by a user of the computing device in regard to the business operation.

6. The method of claim 1, wherein said request included in said message from the computing device comprises a request from a user of the computing device for a telephone call to request help from an associate of the business operation.

7. The method of claim 1, wherein said determining if a location of the computing device satisfies spatial criteria related to the location of the business operation comprises:
receiving global positioning system (GPS) coordinates indicative of the location of computing device; and
determining if the GPS coordinates are within a specified range of the location of the business operation.

8. The method of claim 1, wherein said allowing the computing device to access the customer assistance and/or customer review service associated with the business operation if it is determined that the access criteria of the customer assistance and/or customer review service is satisfied comprises:
activating a feature in the processing system to allow interactive communication between a user of the computing device and an associate of the business operation if it is determined that the access criteria of the customer assistance and/or customer review service is satisfied.

9. The method of claim 8, wherein said activating a feature in the processing system to allow interactive communication between a user of the computing device and a store associate comprises:
defining a view that is displayable on the computing device and includes one or more user interface elements to allow a user of the computing device to choose one or more pre-programmed statements and/or questions to send to a computing device of an associate of the business operation, or allowing said user to customize his or her statements and/or questions; and
defining a view that is displayable on the computing device of the associate of the business operation and includes one or more user interface elements to allow the associated of the business operation to choose one or more pre-programmed responses to send to the computing device of the user.

10. At least one non-transitory computer readable storage medium storing processor-executable instructions that, when executed by at least one processor, result in a method comprising:
receiving a message from a computing device, the message including a request for assistance and/or to provide a review relating to a business operation at a location;
determining if access criteria of a customer assistance and/or customer review service associated with the business operation at the location is satisfied, wherein the access criteria of the customer assistance and/or customer review service comprises spatial criteria related to the location of the business operation, and wherein said determining if the access criteria of the customer assistance and/or customer review service is satisfied comprises determining if a location of the computing device satisfies the spatial criteria related to the location of the business operation; and
allowing the computing device to access the customer assistance and/or customer review service if it is determined that the access criteria of the customer assistance and/or customer review service is satisfied.

11. The at least one non-transitory computer readable storage medium of claim 10, wherein said business operation has business hours at the location of the business operation;
wherein the access criteria of the customer assistance and/or customer review service further comprises temporal criteria related to the business hours of the business operation at the location of the business operation; and
wherein said determining if the access criteria of the customer assistance and/or customer review service is satisfied comprises determining if the location of the computing device satisfies the spatial criteria related to the location of the business operation and determining if the temporal criteria related to the business hours of the business operation is satisfied.

12. The at least one non-transitory computer readable storage medium of claim 11, wherein said determining if the temporal criteria related to the business hours of the business operation is satisfied comprises determining if a time of day at which the message is received satisfies the temporal criteria related to the business hours of the business operation.

13. The at least one non-transitory computer readable storage medium of claim 10, wherein said request included in said message from the computing device comprises a request from a user of the computing device for customer assistance from an associate of the business operation.

14. The at least one non-transitory computer readable storage medium of claim 10, wherein said request included in said message from the computing device comprises a request from a user of the computing device to provide a review by a user of the computing device in regard to the business operation.

15. The at least one non-transitory computer readable storage medium of claim 10, wherein said request included in said message from the computing device comprises a request from a user of the computing device for a telephone call to request help from an associate of the business operation.

16. The at least one non-transitory computer readable storage medium of claim 10, wherein said determining if a location of the computing device satisfies spatial criteria related to the location of the business operation comprises:
receiving global positioning system (GPS) coordinates indicative of the location of computing device; and
determining if the GPS coordinates are within a specified range of the location of the business operation.

17. The at least one non-transitory computer readable storage medium of claim 10, wherein said allowing the computing device to access the customer assistance and/or customer review service associated with the business operation if it is determined that the access criteria of the customer assistance and/or customer review service is satisfied comprises:
activating a feature in the processing system to allow interactive communication between a user of the computing device and an associate of the business operation if it is determined that the access criteria of the customer assistance and/or customer review service is satisfied.

18. The at least one non-transitory computer readable storage medium of claim 17, wherein said activating a feature in the processing system to allow interactive communication between a user of the computing device and a store associate comprises:
defining a view that is displayable on the computing device and includes one or more user interface elements to allow a user of the computing device to choose one or more pre-programmed statements and/or questions to send to a computing device of an associate of the business operation; and
defining a view that is displayable on the computing device of the associate of the business operation and includes one or more user interface elements to allow the associated of the business operation to choose one or more pre-programmed responses to send to the computing device of the user.

19. Apparatus comprising:
a processing system to:
receive a message from a computing device, the message including a request for assistance and/or to provide a review relating to a business operation at a location;
determine if access criteria of a customer assistance and/or customer review service associated with the business operation at the location is satisfied, wherein the access criteria of the customer assistance and/or customer review service comprises spatial criteria related to the location of the business operation, and wherein said determine if the access criteria of the customer assistance and/or customer review service is satisfied comprises determining if a location of the computing device satisfies the spatial criteria related to the location of the business operation; and
allow the computing device to access the customer assistance and/or customer review service if it is determined that the access criteria of the customer assistance and/or customer review service is satisfied.

20. The apparatus of claim 19, wherein said business operation has business hours at the location of the business operation;
wherein the access criteria of the customer assistance and/or customer review service further comprises temporal criteria related to the business hours of the business operation at the location of the business operation; and
wherein said determine if the access criteria of the customer assistance and/or customer review service is satisfied comprises determine if the location of the computing device satisfies the spatial criteria related to the location of the business operation and determine if the temporal criteria related to the business hours of the business operation is satisfied.

21. The apparatus of claim 20, wherein said determine if the temporal criteria related to the business hours of the business operation is satisfied comprises determine if a time of day at which the message is received satisfies the temporal criteria related to the business hours of the business operation.

22. The apparatus of claim 19, wherein said request included in said message from the computing device comprises a request from a user of the computing device for customer assistance from an associate of the business operation.

23. The apparatus of claim 19, wherein said request included in said message from the computing device comprises a request from a user of the computing device to provide a review by a user of the computing device in regard to the business operation.

24. The apparatus of claim 19, wherein said request included in said message from the computing device comprises a request from a user of the computing device for a telephone call to request help from an associate of the business operation.

25. The apparatus of claim 19, wherein said determine if a location of the computing device satisfies spatial criteria related to the location of the business operation comprises:
receive global positioning system (GPS) coordinates indicative of the location of computing device; and
determine if the GPS coordinates are within a specified range of the location of the business operation.

26. The apparatus of claim 19, wherein said allow the computing device to access the customer assistance and/or customer review service associated with the business operation if it is determined that the access criteria of the customer assistance and/or customer review service is satisfied comprises:
activate a feature in the processing system to allow interactive communication between a user of the computing device and an associate of the business operation if it is determined that the access criteria of the customer assistance and/or customer review service is satisfied.

27. The apparatus of claim 26, wherein said activate a feature in the processing system to allow interactive communication between a user of the computing device and a store associate comprises:
define a view that is displayable on the computing device and includes one or more user interface elements to allow a user of the computing device to choose one or more pre-programmed statements and/or questions to send to a computing device of an associate of the business operation; and
define a view that is displayable on the computing device of the associate of the business operation and includes one or more user interface elements to allow the associated of the business operation to choose one or more pre-programmed responses to send to the computing device of the user.
